(19) United States
(12) Patent Application Publication
(10) Pub. No.: US 2024/0354675 A1
(43) Pub. Date: Oct. 24, 2024

(54) RELATIONAL DATA BASE MANAGEMENT SYSTEMS

(71) Applicant: Truist Bank, Charlotte, NC (US)

(72) Inventor: David Alan Lane, Snellville, GA (US)

(73) Assignee: Truist Bank, Charlotte, NC (US)

(21) Appl. No.: 18/305,472

(22) Filed: Apr. 24, 2023

(51) Int. Cl. G06Q 10/0631; G06Q 10/0639; G06Q 10/1053

(52) U.S. Cl. CPC G06Q 10/06315; G06Q 10/063112; G06Q 10/06398; G06Q 10/1053

(57) ABSTRACT

Systems and methods receive, by a relational database management system (RDMS) from a user device via a network, user input(s) indicating (a) demand of attribute(s) and (b) an associated requirement level needed to satisfy the demand, the user input(s) being provided via user interface input control(s) displayed via a user interface of the user device. The RDMS performs unit resource management that includes (i) retrieving data stored by database(s) of the RDMS, the data comprising a plurality of stored unit profiles each comprising associated unit attributes, and (ii) filtering the data to select stored unit profile(s) comprising associated unit attributes determined to align with the demand of the attribute(s). An output comprising the selected stored unit profile(s) is transmitted to computing device(s) via the network, the transmitting facilitating displaying the output via the computing device(s).

### FIELD OF THE INVENTION

This invention relates generally to the field of relational database, and more particularly embodiments of the invention relate to relational database management systems and methods.

### BACKGROUND OF THE INVENTION

Many enterprises (e.g., companies, universities, organizations, institutions, etc.) commonly implement various human resource management systems (HRMS) to manage human resources and related processes throughout the employee lifecycle. Various HRMS help administrative levels of an enterprise to understand its workforce and comply with various regulations, laws, company objectives, etc. HRMS can generate data on various workforce needs and can provide insights into various business strategies.

Although existing HRMS may assist with various administrative functions, HRMS also have many deficiencies, particularly for large enterprises that employ thousands of employees across various worksites, geographical areas, and departments. Managers and other HRMS administrators may lack visibility into various candidate management, employee management, and employee engagement functions that may facilitate improved human capital resource optimization options for the enterprise.

Thus, a need exists for improved systems and methods for human capital resource optimization.

### BRIEF SUMMARY

Shortcomings of the prior art are overcome and additional advantages are provided through the provision of a relational database management system for unit resource management. The system includes a memory, one or more processors in communication with the memory, and program instructions executable by the one or more processors. In particular, the program instructions are executable to, in part, receive, by the relational database management system from a user device via a network, one or more user inputs indicating (a) demand for one or more attributes and (b) an associated requirement level needed to satisfy the demand, where the one or more user inputs are provided via one or more user interface input controls displayed via a user interface of the user device. The relational database management system performs unit resource management, where the performing includes retrieving data stored by one or more databases of the relational database management system, the data including a plurality of stored unit profiles each including associated unit attributes. Further, the performing includes filtering the data to select one or more stored unit profiles that includes associated unit attributes determined to align with the demand of the one or more attributes. In addition, an output comprising the selected one or more stored unit profiles is transmitted to one or more computing devices via the network, where the transmitting facilitates displaying the output via the one or more computing devices.

Additionally, disclosed herein is a computing system for database server querying. The computing system includes one or more computer readable storage media, one or more processors in communication with the one or more computer readable storage media, and program instructions executable by the one or more processors via at least one computer readable storage medium of the one or more computer readable storage media. In particular, the program instructions are executable to, in part, receive by a server from a user device via a network one or more queries indicating (a) demand of one or more human capital skillsets within a segment of an enterprise and (b) an associated competency level needed to satisfy the demand. The server performs strategic resource management, where the performing includes retrieving data comprising a plurality of stored resource profiles, each resource profile having associated human capital skillsets, and identifying one or more stored resource profiles of one or more individuals from the plurality of stored resource profiles, the one or more stored resource profiles including a plurality of associated skillsets, the one or more stored resources profiles being identified based on one or more human capital skillsets of the one or more individuals most closely aligning to the demand. The program instructions are further executable to transmit, to one or more computing devices via the network, an output including the one or more stored resource profiles of the one or more individuals, the transmitting facilitating displaying the output via the one or more computing devices.

Also disclosed herein is a computer-implemented method for unit resource management. The computer-implemented method includes, in part, receiving, by a relational database management system from a user device via a network, one or more user inputs associated with unit resource management, the one or more user inputs indicating: (a) position data associated with a position of the enterprise, (b) demand for one or more unit resources comprising one or more attributes, and (c) an associated requirement level needed to satisfy the demand, wherein the one or more user inputs are provided via one or more user interface input controls displayed via a user interface of the user device. The method also includes comparing the one or more user inputs to a plurality of threshold requirements needed to certify all data provided via the one or more user inputs. In addition, the method includes transmitting, to one or more computing devices via the network, and displaying, via the one or more computing devices, an output indicating whether all of the data provided via the one or more user inputs satisfies the plurality of threshold requirements.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

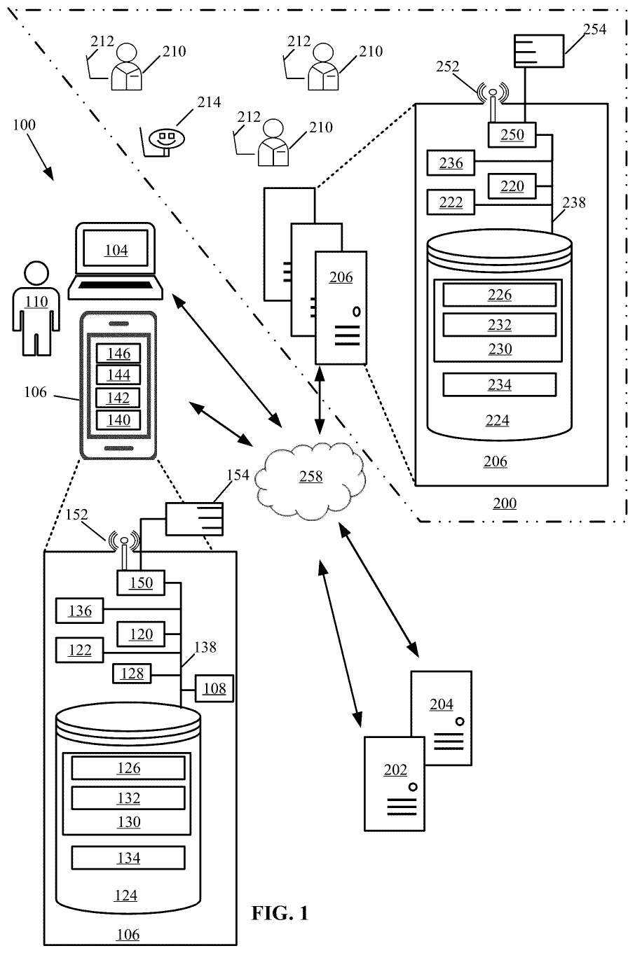

FIG. 1 illustrates a computing environment that includes a relational database management system, in accordance with an embodiment of the present invention;

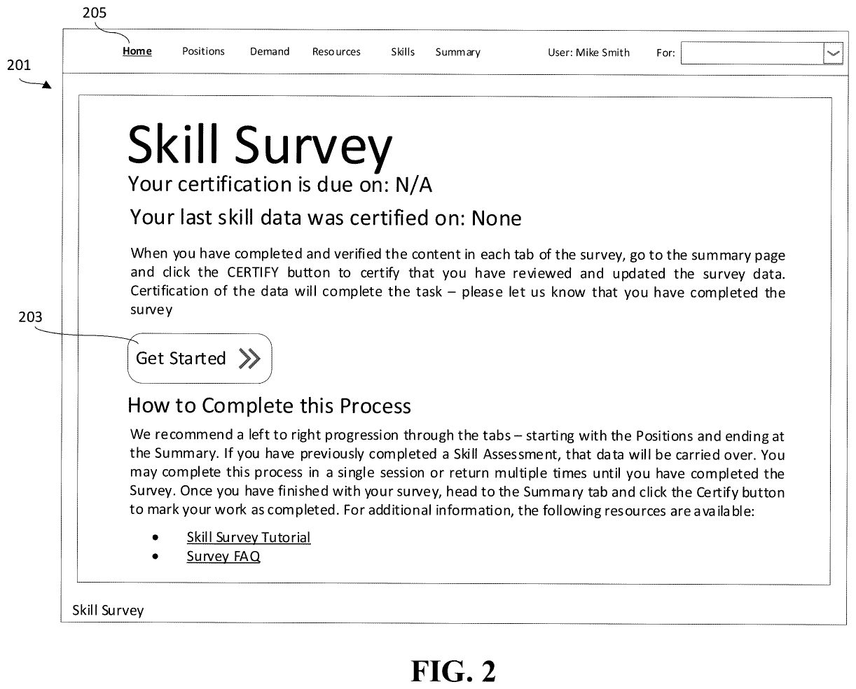

FIG. 2 depicts an example user interface display for initiating a skill survey, in accordance with an embodiment of the present invention;

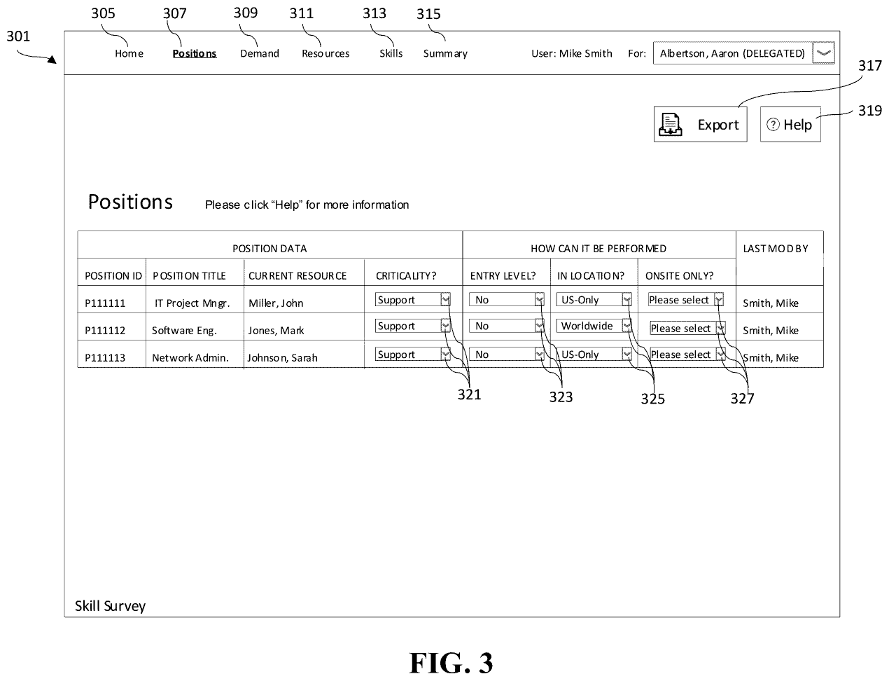

FIG. 3 depicts an example user interface display for inputting position information as part of a skill survey, in accordance with an embodiment of the present invention;

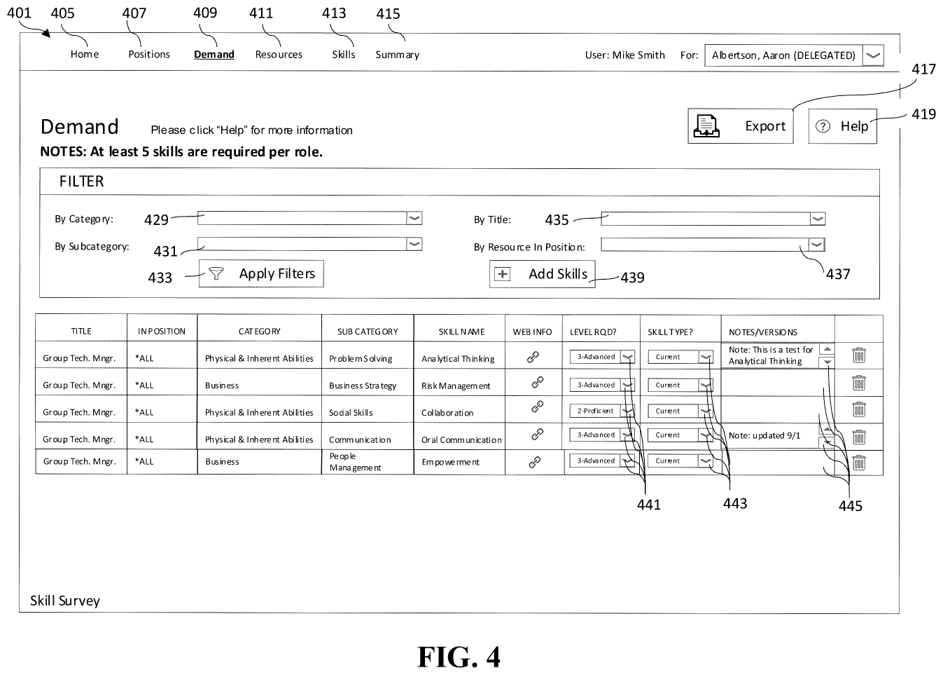

FIG. 4 depicts an example user interface display for providing user inputs related to skill demands required for various roles, in accordance with an embodiment of the present invention;

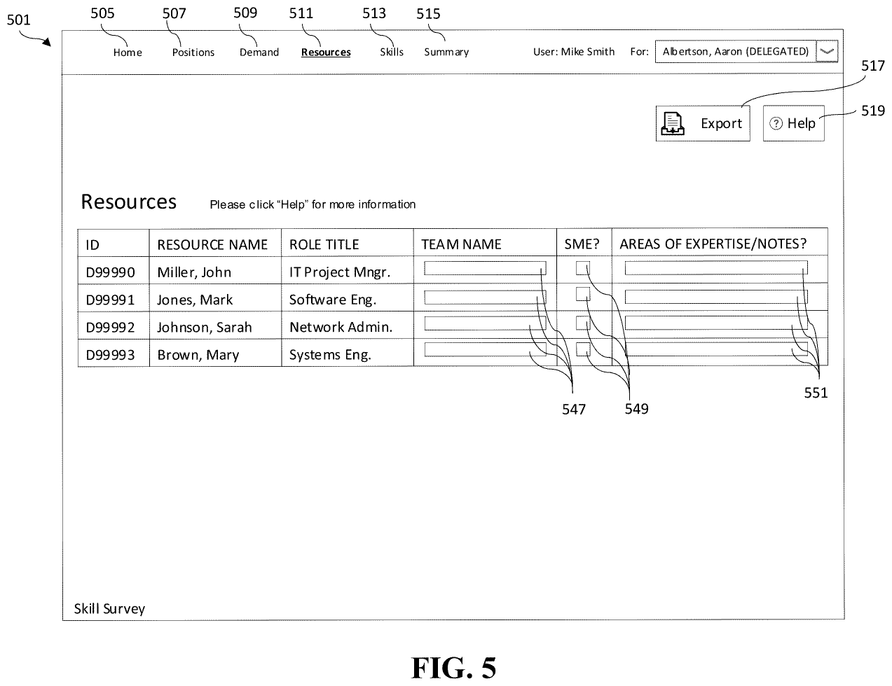

FIG. 5 depicts an example user interface display for providing user inputs related to existing personnel resources associated with an entity, in accordance with an embodiment of the present invention;

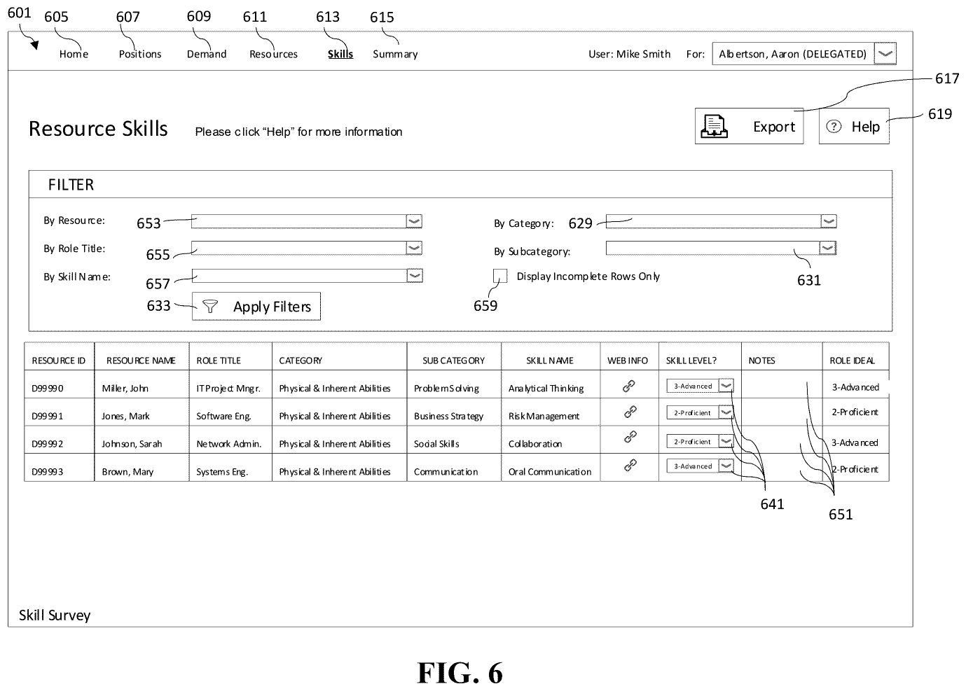

FIG. 6 depicts an example user interface display for providing inputs to filter results of existing personnel resources to identify necessary resource skills associated with an entity, in accordance with an embodiment of the present invention;

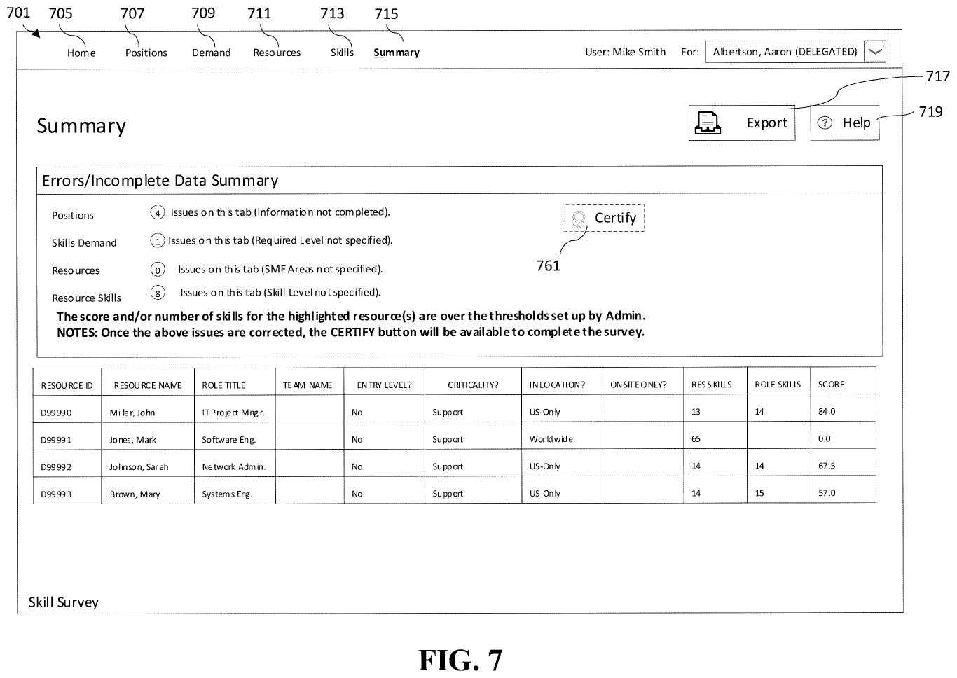

FIG. 7 depicts an example user interface display for summarizing inputs provided by the user and identifying errors, and also for certifying the skill demand needed by the enterprise, in accordance with an embodiment of the present invention;

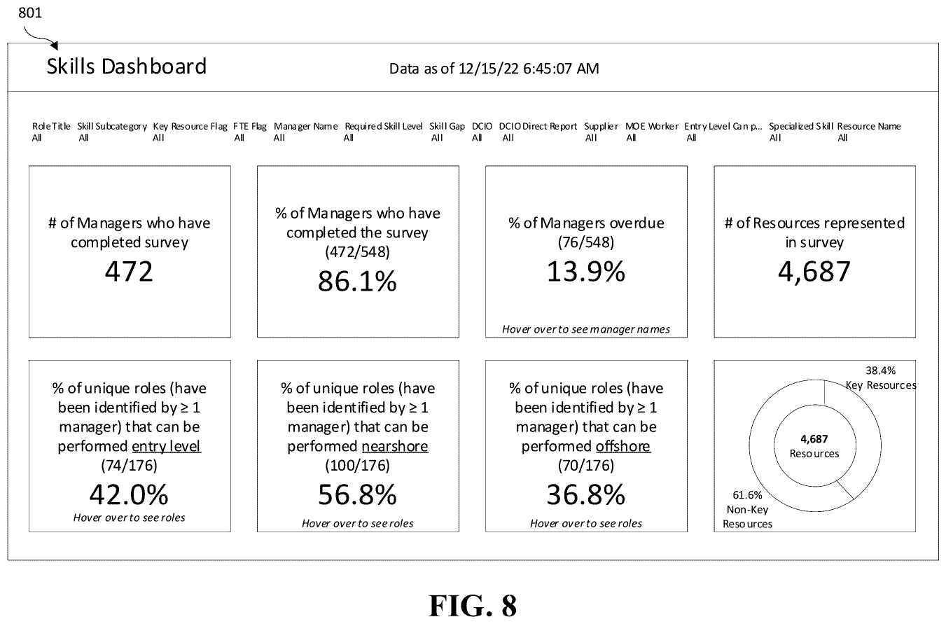

FIG. 8 depicts an example user interface display that includes a skills dashboard summarizing results of the skill survey, in accordance with an embodiment of the present invention;

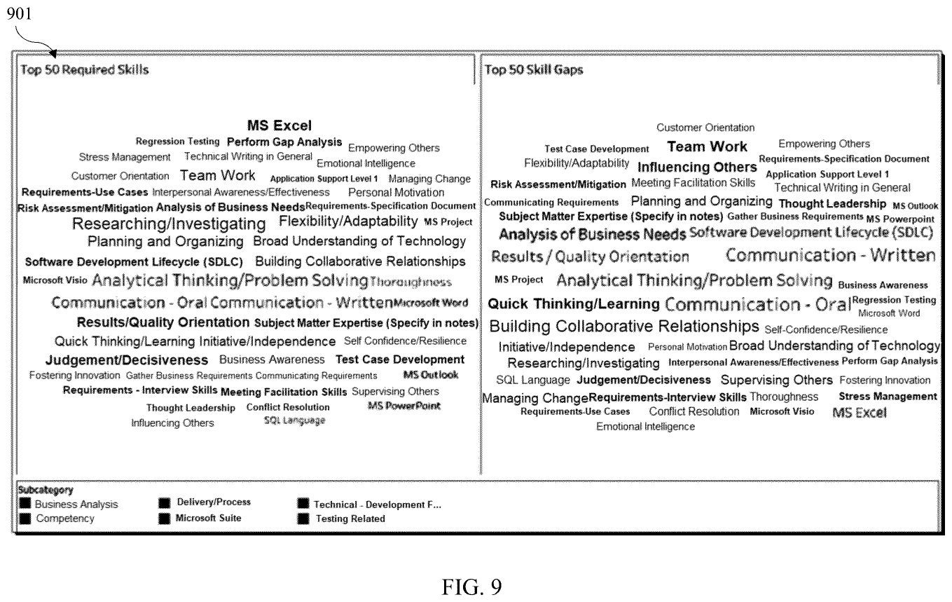

FIG. 9 depicts an example user interface display that includes a word cluster diagram of the top required skills identified by the skill survey, in accordance with an embodiment of the present invention;

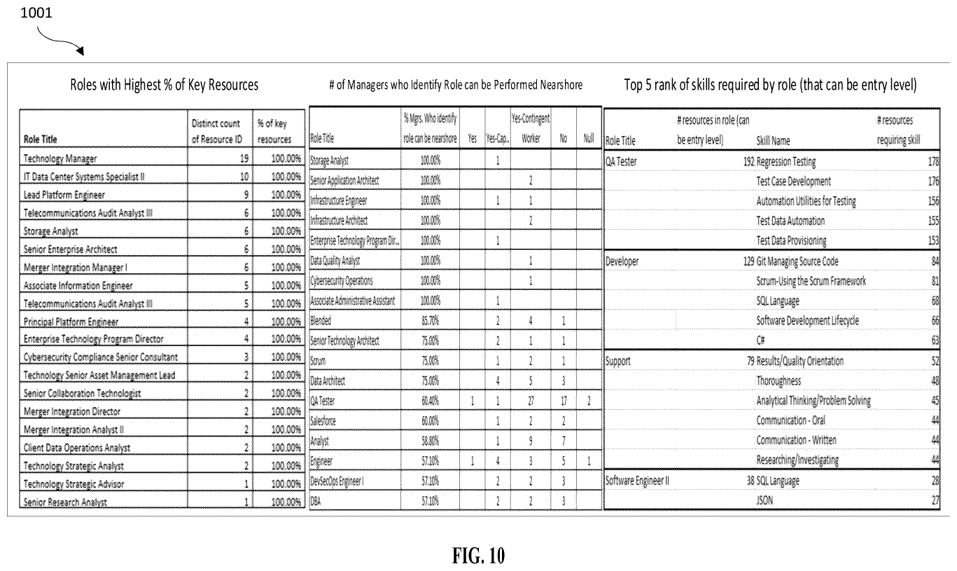

FIG. 10 depicts an example user interface display that includes a data summary of information derived from the skill survey, in accordance with an embodiment of the present invention;

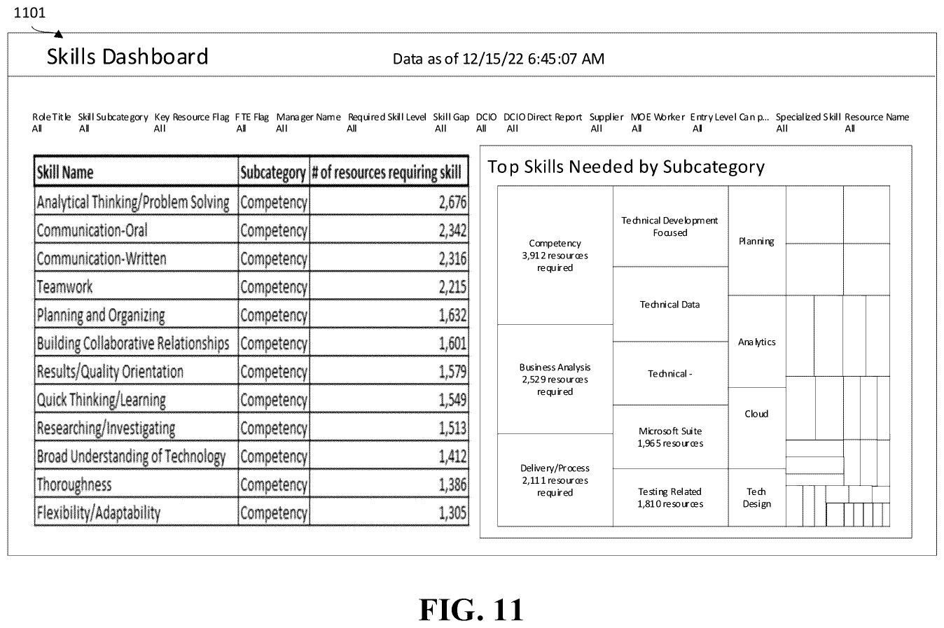

FIG. 11 depicts an example user interface display that includes a skills dashboard that includes a data summary of information derived from the skill survey, in accordance with an embodiment of the present invention;

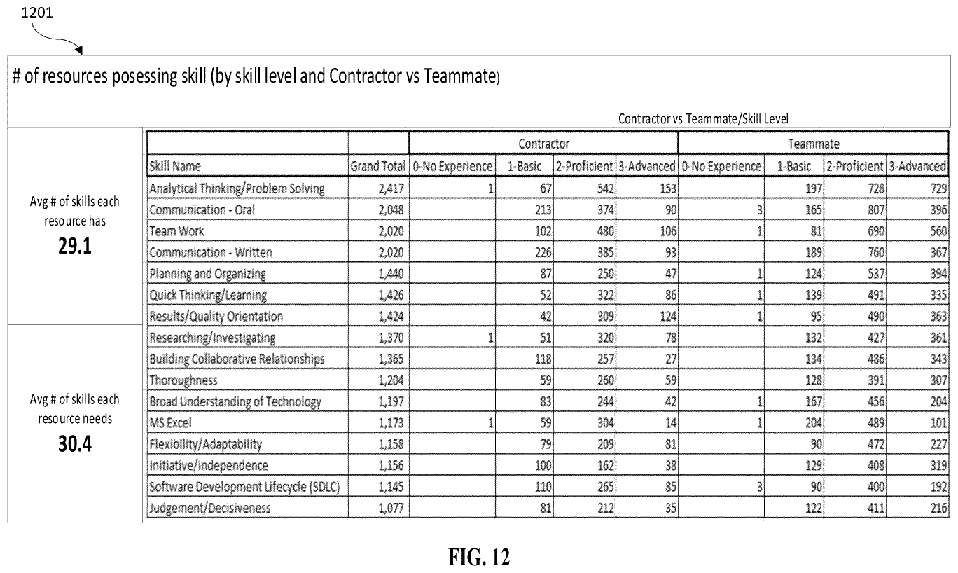

FIG. 12 depicts an example user interface display that includes a data summary of information derived from the skill survey, in accordance with an embodiment of the present invention;

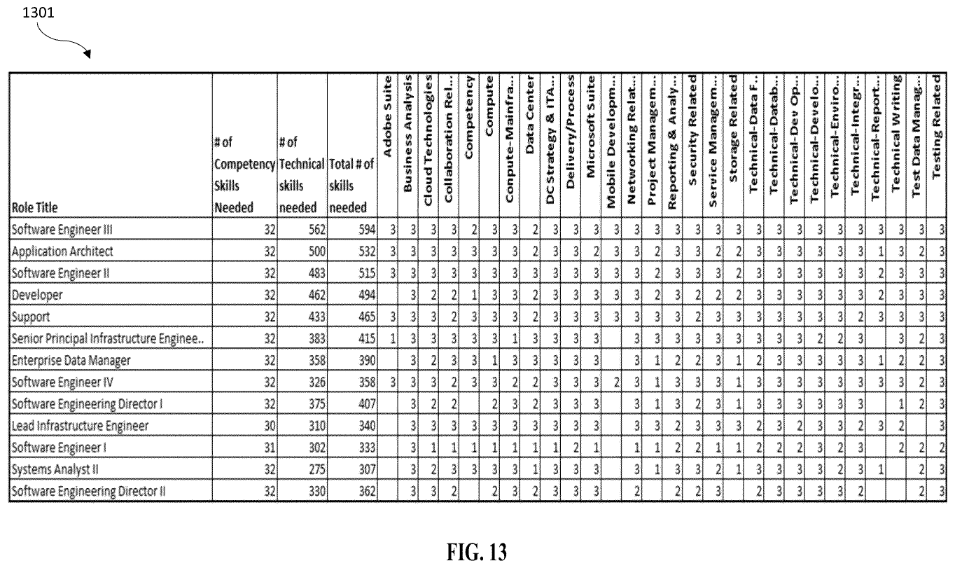

FIG. 13 depicts an example user interface display that includes a data summary of information derived from the skill survey, in accordance with an embodiment of the present invention;

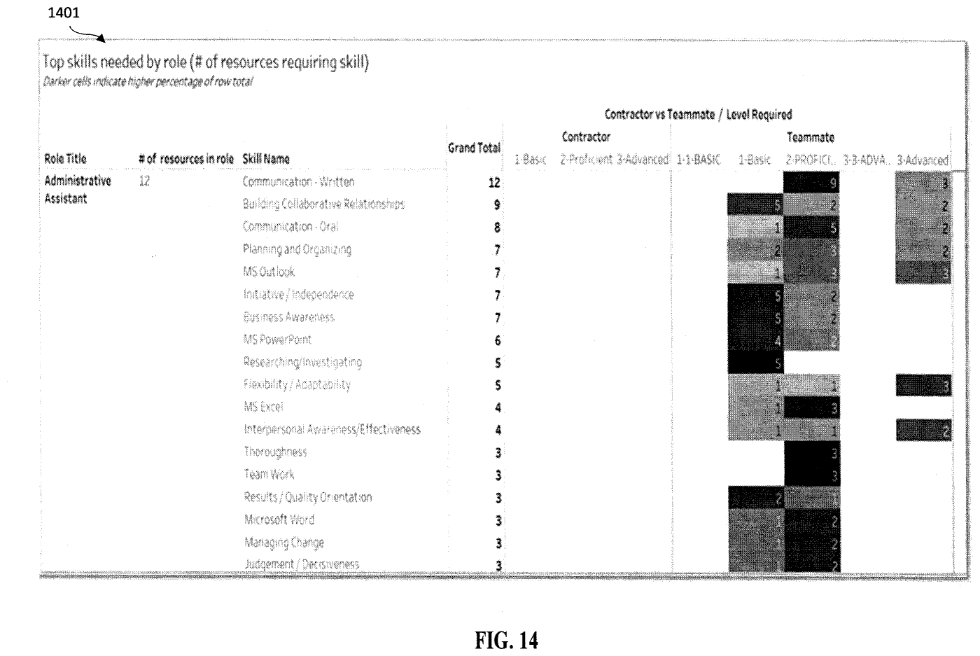

FIG. 14 depicts an example user interface display that includes a data summary of information derived from the skill survey, in accordance with an embodiment of the present invention;

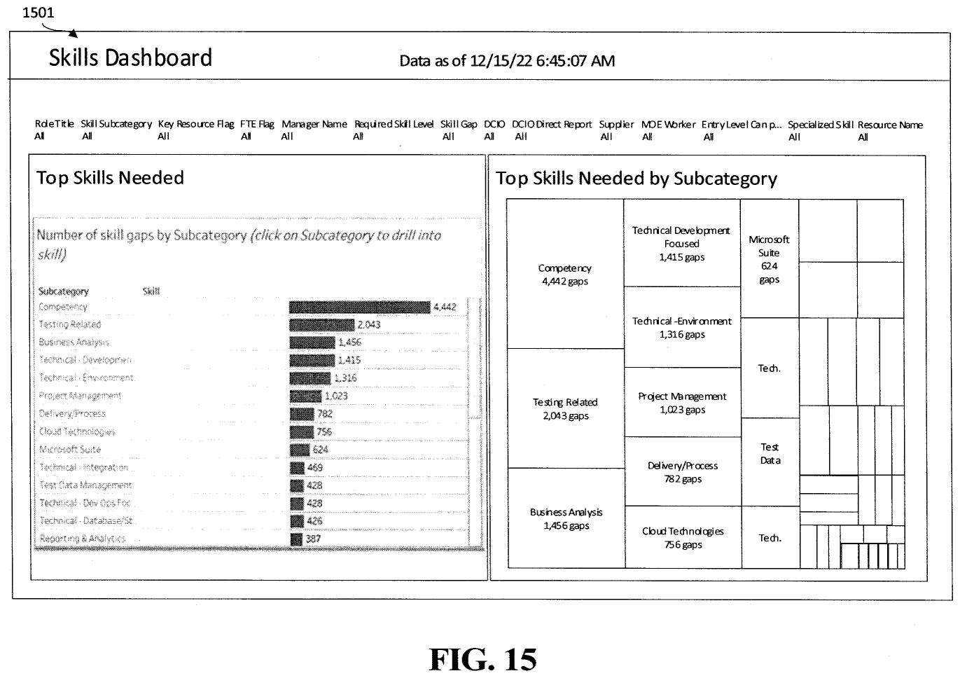

FIG. 15 depicts an example user interface display that includes a skills dashboard that includes a data summary of information derived from the skill survey, in accordance with an embodiment of the present invention;

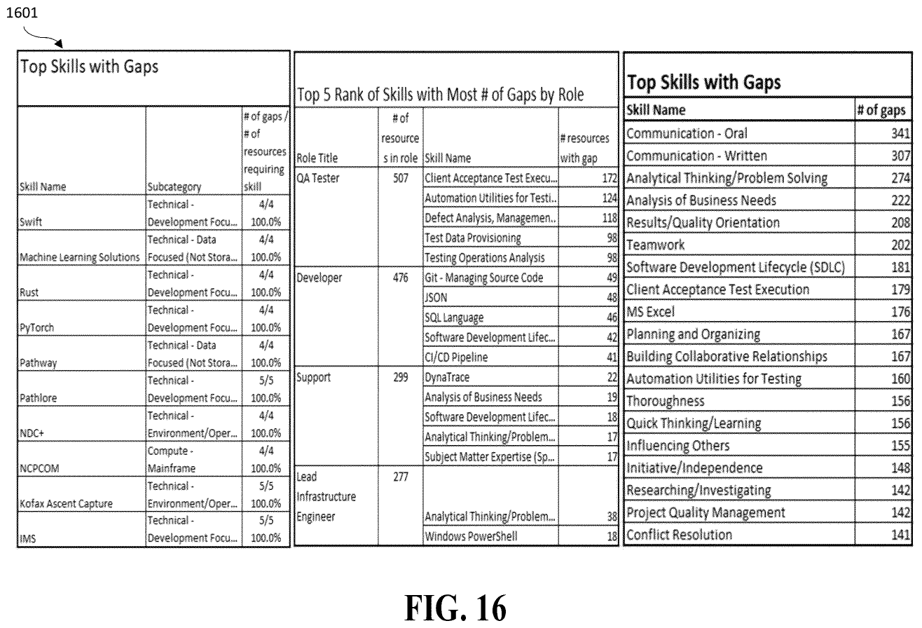

FIG. 16 depicts an example user interface display that includes a data summary of information derived from the skill survey, in accordance with an embodiment of the present invention;

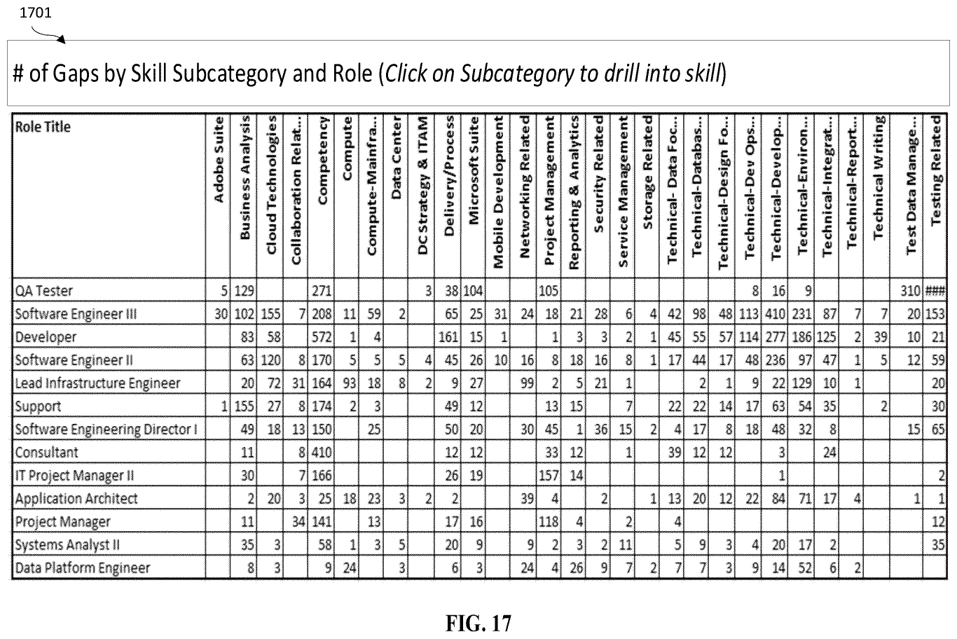

FIG. 17 depicts an example user interface display that includes a data summary of information derived from the skill survey, in accordance with an embodiment of the present invention;

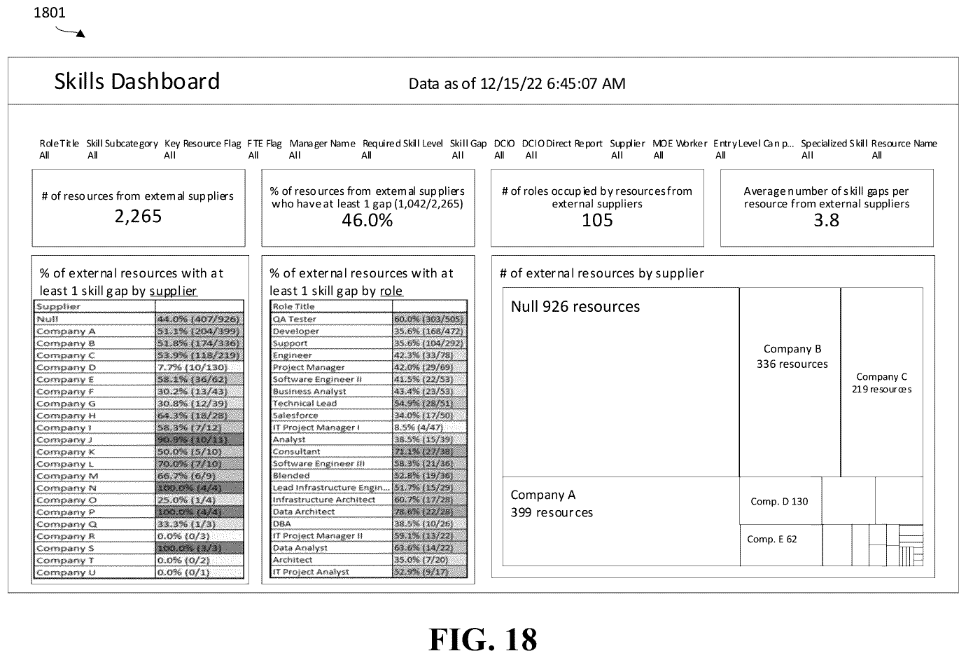

FIG. 18 depicts an example user interface display that includes a skills dashboard that includes a data summary of information derived from the skill survey, in accordance with an embodiment of the present invention;

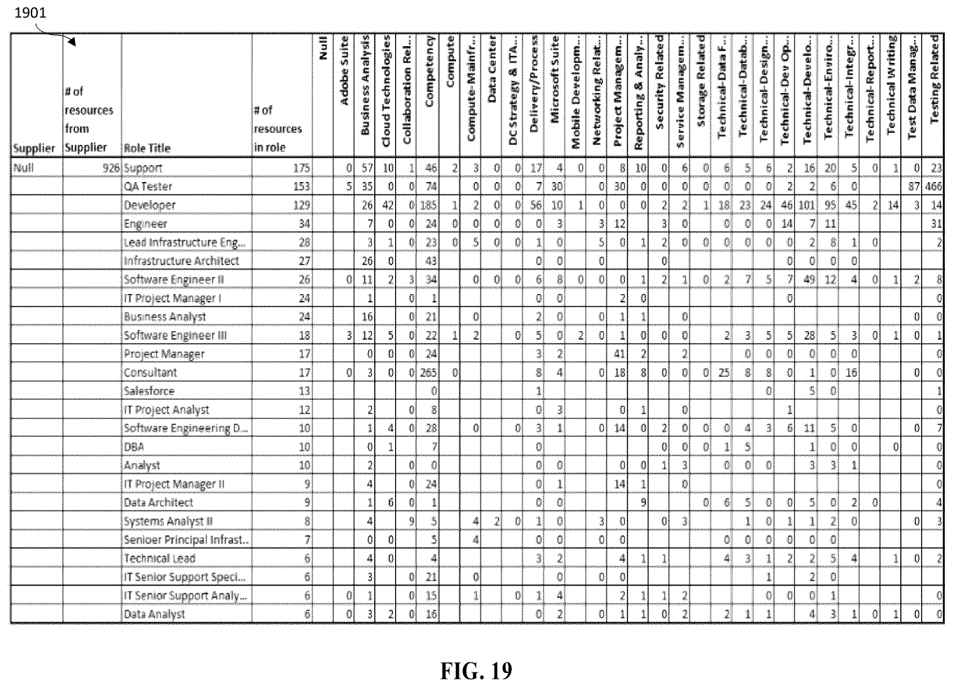

FIG. 19 depicts an example user interface display that includes a data summary of information derived from the skill survey, in accordance with an embodiment of the present invention;

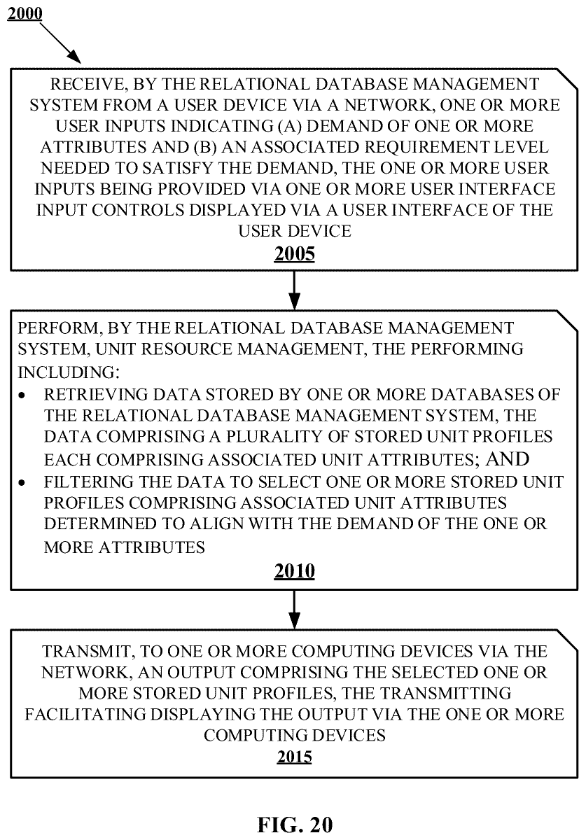

FIG. 20 depicts a block diagram of an example method for unit resource management, in accordance with an embodiment of the present invention;

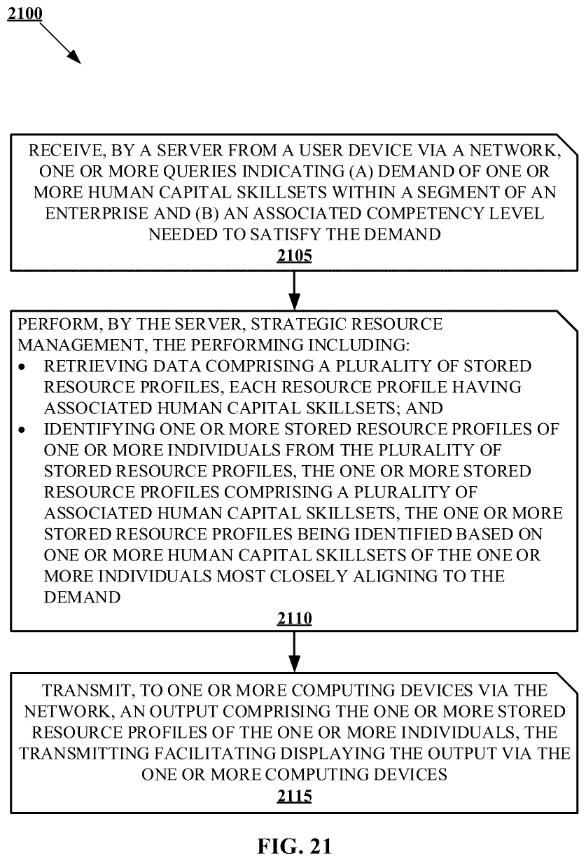

FIG. 21 depicts a block diagram of an example method for unit resource management, in accordance with an embodiment of the present invention; and

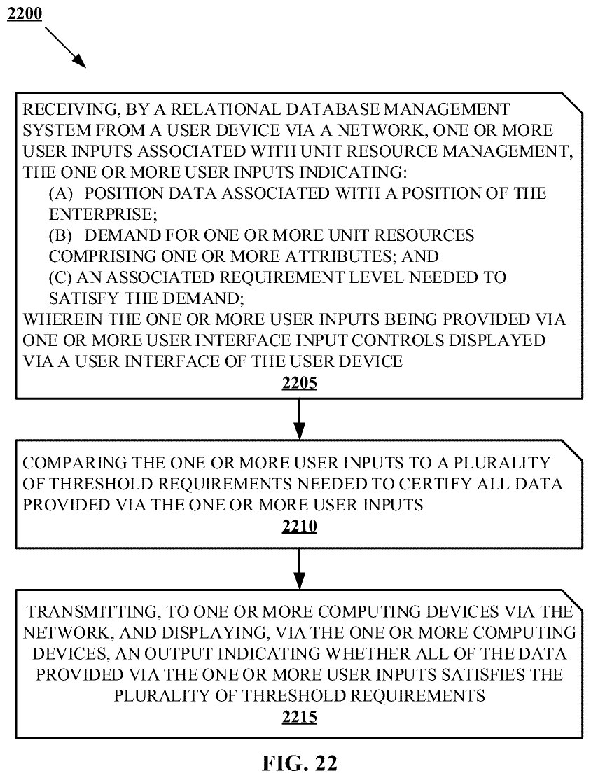

FIG. 22 depicts a block diagram of an example method for unit resource management, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment”, “an embodiment”, “various embodiments”, “one or more embodiments”, etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

Like numbers refer to like elements throughout. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “couple”, “coupled”, “couples”, “coupling”, “fixed”, “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about”, “approximately”, or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

As used herein, the terms “enterprise” or “provider” generally describes a person or business enterprise that hosts, maintains, or uses computer systems that provide functionality for the disclosed systems and methods. In particular, the term “enterprise” may generally describe a person or business enterprise providing goods or services. Interactions between an enterprise system and a user device can be implemented as an interaction between a computing system of the enterprise and a user device of a user. For instance, user(s) may provide various inputs that can be interpreted and analyzed using processing systems of the user device and/or processing systems of the enterprise system. Further the enterprise computing system and the user device may be in communication via a network. According to various embodiments, the enterprise system and/or user device(s) may also be in communication with an external or third-party server of a third party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein, with reference to flowchart illustrations and/or block diagrams of computer-implemented methods and computing systems according to embodiments of the invention. Each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus or apparatuses (the term “apparatus” includes systems and computer program products). In particular, the computer readable program instructions, which be executed via the processor of the computer or other programmable data processing apparatus, create a means for implementing the functions/acts specified in the flowchart and/or block diagram block or blocks.

In one embodiment, these computer readable program instructions may also be stored in one or more computer-readable storage media that can direct a computer or other programmable data processing apparatus, and/or other devices, to function in a particular manger, such that a computer readable storage medium of the one or more computer-readable storage media having instructions stored therein comprises an article of manufacture including instructions which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block or blocks.

In another embodiment, these computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions, whether stored in the computer-readable storage medium and/or computer-readable memory may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable instructions for implementing the specified logical function(s). Additionally, the alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, or the functions of the blocks may sometimes be executed in the reverse order, depending upon the functionality involved.

FIG. 1 illustrates a computing environment 100 that includes a relational database management system, according to at least one embodiment of the present invention. The computing environment 100 generally includes a user 110 that benefits through use of services and products offered by a provider through an enterprise system 200. The computing environment 100 may include, for example, a distributed cloud computing environment (private cloud, public cloud, community cloud, and/or hybrid cloud), an on-premise environment, fog-computing environment, and/or an edge-computing environment. The user 110 accesses services and products of the enterprise system 200 by use of one or more user devices 104, 106. Example user devices 104, 106 may include a laptop, desktop computer, tablet, a mobile computing device such as a smart phone, a portable digital assistant (PDA), a pager, a mobile television, a gaming device, an audio/video player, a virtual assistant device or other smart home device, a wireless personal response device, or any combination of the aforementioned, or other portable device with processing and communication capabilities.

In the illustrated example, the mobile device 106 is illustrated in FIG. 1 as having exemplary elements, the below descriptions of which apply as well to the computing device 104. The user device 104, 106 can include integrated software applications that manage device resources, generate user interfaces, accept user inputs, and facilitate communications with other devices among other functions. The integrated software applications can include an operating system, such as Linux®, UNIX®, Windows®, macOS®, iOS®, Android®, or other operating system compatible with personal computing devices. Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system used on personal computers, central computing systems, phones, and other devices.

The user 110 can be an individual, a group, or any entity in possession of or having access to the user device 104, 106, which may be personal, enterprise, or public items. Although the user 110 may be singly represented in some figures, in at least in some embodiments the user 110 is one of many such that a market or community of users, consumers, customers, business entities, government entities, clubs, and groups of any size.

The user device 104, 106, but as illustrated with reference to the mobile device 106, includes components such as, at least one of each of a processor 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processor 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user, or required or related to any or all of the applications or programs 130.

The memory device 122 is operatively coupled to the processor 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory additionally or alternatively can include an electrically erasable programmable read-only memory (EEPROM), flash memory or the like.

According to various embodiments, the memory device 122 and storage device 124 may be combined into a single storage medium. The memory device 122 and storage device 124 can store any of a number of applications that comprise computer-executable instructions and code executed by the processing device 120 to implement the functions of the user device 104, 106 described herein. For example, the memory device 122 may include such applications as a conventional web browser application and/or an enterprise-distributed application (e.g., a mobile application), collectively referred to herein as a “web portal”. These applications also typically provide a graphical user interface (GUI) on the display 140 that allows the user 110 to communicate via the user device 104, 106 with, for example, an enterprise system 200, and/or other devices or systems. For instance, the GUI on the display 140 may include features for displaying information and accepting inputs from users, and may include fillable text boxes, data fields, hyperlinks, pull down menus, check boxes, and the like. In one embodiment, when the user 110 may participate in a digital data collection program to indicate attributes associated with human capital resources of an enterprise, such as the enterprise associated with the enterprise system 200.

In particular, in various embodiments, the user 110 may download, sign into, or otherwise access an enterprise-based data collection program from an enterprise system 200 or from a distinct application server such as, for example, a relational database management system. In other embodiments, the user 110 interacts with the enterprise system 200 via a web browser application in addition to, or instead of, the downloadable client application.

As defined herein, a relational database management system (RDBMS) may include a collection of programs and capabilities that enable individuals to create, update, administer and otherwise interact with one or more relational databases. In non-limiting examples, the RDBMS may store data in the form of tables and may utilize structured query language (SQL) to access data stored to the one or more relational databases. In some embodiments, the one or more relational databases may include a distributed database that runs and stores data across multiple computers. The RDBMS may include data dictionaries or metadata repositories that include information about the data, relationships of the data, origin, usage, etc. The RDBMS may utilize one or more algorithms that support concurrent user access by multiple users, provide data integrity, monitoring of database activity, automated data loading, database backup and various other operational parameters. In some non-limiting examples, the RDBMS may include a Microsoft SQL Server® database developed by Microsoft® or other similar RDBMSes such as Oracle Database, MySQL, IBM DB2, and the like. Various embodiments of the RDBMS may include varying number of tables comprising records and fields. The RDBMS may include primary keys used to identify each row of the table(s) to facilitate RDBMS queries.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices may include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices of the input and output system 136 may include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

According to one embodiment, the input and output system 136 may include an optical instrument (e.g., camera 146) configured to detect presence of a scannable object within an image. For instance, the optical instrument may include one or more lenses and one or more image sensors (e.g., a charge coupled device (CCD) sensor) configured to convert photons into an electrical signal. For example, pixels of each the image sensors may each include a photodiode (e.g., a semiconductor) that becomes electrically charged in accordance with the strength of the light that strikes the photodiode, where the electrical charge is then relayed to be converted to an electrical signal. In one embodiment, a series of pulses may be applied to the one or more image sensors to relay the accumulate charges within each photodiode in succession down a row of photodiodes to an edge of the respective image sensor. Other optical instrument functionalities are also contemplated herein.

In some embodiments, a credentialed system is not required in order to access a web portal of the enterprise system 200, whereas in other embodiments authentication of a user may be necessary in order to provide access to a web portal. In one embodiment, the input and output system 136 may also be configured to obtain and process various forms of authentication to obtain authentication information of a user 110 in order to provide, for example, access to a specific web portal of the enterprise system 200. For instance, the web portal may be accessed based on the user providing authentication information to log in to the web portal in order to perform various functionalities described herein. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a GPS configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138 (e.g., system bus), connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, short message service (SMS), enterprise messaging service (EMS), multimedia messaging service (MMS) messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, Global Positioning System (GPS) may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, a single system or server may provide the functions of one or more systems, servers, or illustrated components. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers a web-based data collection service to upload information to a RDBMS. In some non-limiting examples, the enterprise system 200 offers a web-based human capital product that enterprise management can utilize to fill gaps in skillsets and competencies within the enterprise. Use of the words “service(s)” or “product(s)” herein can be interchangeable.

To provide access to, or information regarding, some or all the services and products of the enterprise system 200, management or other individuals may need to provide inputs and data from which the RDBMS can draw in order to provide information and/or responses to queries. In at least some examples, any number of managers 210 can be employed, utilized, authorized or referred by the enterprise system 200 to provide inputs of data to the RDBMS. Managers 210 may utilize computing devices 212 to facilitate providing information and data to the user 110.

The enterprise system 200 can be accessed, used, or controlled, in whole or in part, by an enterprise (e.g., companies, employers, organizations, institutions, etc.) directly or tangentially associated with the user 110. For instance, as non-limiting examples, the enterprise may be an employer of the user 110, a third-party commercial employment agency, an outsourced human resource agency, a human resource service provider, a talent agency, a research company, and/or various other agencies, associations, or enterprises that may be involved in surveying skills and needs of an enterprise and/or identifying existing human capital resources available to an enterprise. Various other enterprises are also contemplated herein.

The enterprise system 200 may employ a web-based framework with a user interface, a back-end server data model, and tableau reporting to capture each manager's view of the demand within their roles and positions and their assessment of each resources' ability in order to provide micro-level and macro-level insights. The enterprise system may leverage computing device 104 or mobile device 106 to allow the user 110 to access various tools and functionalities associated with the skills survey and insights. Various embodiments may utilize some, all, or none of several functionalities, tools, components, or processes such as data processing, resource allocation, monitoring activities, disk and file management, communications, presentations, cybersecurity, artificial intelligence, machine learning, etc. The program or system may be compiled or otherwise generated, transmitted, and/or distributed, using machine code that can be executed by a server (e.g., a SQL server), the computing device 104, and/or mobile device 106. Various systems, programs, and/or portions thereof may be fully automated and/or incorporate user inputs. For instance, a relational database management system for unit resource management may utilize managers 210 and/or automated system(s) 214 that generate one or more digital communications and/or data collection sequence(s) that can be transmitted or otherwise distributed or provided to the user device 104, 106. Any number of managers 210 and/or automated system(s) 214 may be employed or utilized by the enterprise system 200. Non-limiting examples of managers 210 can include employees, contractors, consultants, advisors, managers, or other individuals associated with the enterprise system 200.

In various examples, the program or system may be compiled utilizing a Platform as a Service (PaaS) or Infrastructure as a Service (IaaS) that the managers 210 can access to compile the program or system. A PaaS does not permit the managers 210 to manage or control the underlying cloud infrastructure, but this service may enable the managers 210 to deploy user-created or acquired applications onto the cloud infrastructure using programming languages and tools provided by the provider of the application. A IaaS provides the managers 210 with permission to provision processing, storage, networks, and other computing resources as well as run arbitrary software (e.g., operating systems and applications) thereby giving the managers 210 full control over operating systems, storage, deployed applications, and potentially select networking components (e.g., host firewalls).

Managers 210 may utilize enterprise devices 212 to assist in compiling the program or system. The enterprise devices 212 can be a personal computer, a smart phone, or tablet computing device, and/or other mobile/computing device(s). Further, in some examples, the diagrammatic representation of the components of user device 104, 106 also apply to the enterprise devices 212. Enterprise device(s) 212 individually or collectively include input and output devices, (e.g., a touch screen, a monitor, a keyboard, etc.) for the managers 210 to input and receive information. Other non-limiting examples of input and output devices or components utilized by the enterprise device(s) 212 include one or more of each, any, and all of a keypad, a wireless or wired keyboard, a touch-screen, a touchpad, a microphone, a speaker, a mouse, a joystick, a pointer device, a button, a switch, a light, an LED, a soft key, an infrared sensor, personal response device, a camera (e.g., a digital camera), a buzzer, a bell, a printer and/or other input and output device(s). Inputs made via the input/output devices of the enterprise device(s) 212 by one or more managers 210 can be made via voice, text or graphical indicia selections in order to facilitate compilation of the program or system that is to communicate with the user device 104, 106. According to various embodiments, enterprise device(s) 212 may primarily serve as inputs or outputs to the computing system 206 of the enterprise system 200. Automated system(s) 214 may incorporate or otherwise utilize artificial intelligence to facilitate compilation of the program or system. For instance, the automated system(s) 214 may generate digital communications (e.g., queries, questions, inquiries, etc.) and/or data collection sequences (e.g., queries, questions, audio submission requests, image submission requests, description requests, etc.). In some embodiments, automated system(s) 214 may also perform natural language processing on audio data obtained once a speech signal processing system performs audio transduction on a speech signal to generate the audio data. According to various embodiments, automated system(s) 214 may primarily serve as inputs or outputs to the computing system 206 of the enterprise system 200.

The enterprise system 200 can be configured to generate data manually or to obtain data from a third party source such as, for example, a cloud storage service or remote database. Such data that may be generated, downloaded, or otherwise obtained may include, for example, role-related data that can be used by a computing system 206 to identify skills required by a role. In one example, the automated system(s) 214 or managers 210 may access third party systems using a software application (e.g., an integrated mobile software application or an application programming interface (API) software application) compatible with the third party system that can be integrated with the computing system 206 and accessible via the enterprise device(s) 212 to facilitate communication between software and systems. In another embodiment, the managers 210 access third-party systems using a web browser application software to access a web-based software interface (e.g., a website).

The computing system 206 may have various components similar to the user device 104, 106. For instance, in one example the computing system 206 may include at least one of each of a processing device 220, and a memory device 222 for use by the processing device 220, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data and files, such as those for user accounts or user profiles, worksite data, enterprise data, company data, industry data, historical data, files downloaded or received from other devices, and other data items preferred by the enterprise or required or related to any or all of the applications or programs 230. In one non-limiting example, the computing system 206 may include applications or programs 230 that incorporate software that provides natural language processing and/or image recognition.

As illustrated, the computing system 206 includes an input/output system 236, which generally refers to, includes, and/or is operatively coupled with enterprise device(s) 212 and automated system(s) 214, as well as various other input and output devices. According to various embodiments, the computing system 206 may be used to distribute the digital data collection program as, for example a Software-as-a-Service (SaaS) that can be accessed by the user device 104, 106 on a subscription basis via a web browser or mobile application. SaaS may provide a user 110 with the capability to use applications running on a cloud infrastructure of the enterprise system 200, where the applications are accessible using the user device 104, 106 via a thin client interface such as a web browser and the user 110 is not permitted to manage or control the underlying cloud infrastructure (i.e., network, servers, operating systems, storage, or specific application capabilities that are not user-specific) of the enterprise system 200.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device 104, 106.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, near-field communication device, and other transceivers. In addition, GPS (Global Positioning System) may be included for navigation and location-related data exchanges, ingoing and/or outgoing. Communications may also, or alternatively, be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the computing device 104 and mobile device 106, the enterprise device(s) 212, and the enterprise computing system 206, which may be one or any number centrally located or distributed, are in communication through one or more networks, referenced as network 258 in FIG. 1.

The network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of this description. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMAX, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, frames using frame relay, voice, video, data, and other suitable information between network addresses. The network 258 may also include one or more local area networks (LANs), radio access networks (RANs), metropolitan area networks (MANs), wide area networks (WANs), personal area networks (PANs), WLANs, campus area network (CAN), metropolitan area network (MAN), storage-area network (SAN), all or a portion of the internet and/or any other communication system or systems at one or more locations.

The network 258 may incorporate a cloud platform/data center that support various service models including Platform as a Service (PaaS), Infrastructure-as-a-Service (IaaS), and/or Software-as-a-Service (SaaS). The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, third-party PaaS, third-party IaaS, external databases, business entities, enterprises, organizations, institutions, companies, government entities, clubs, and groups of any size are all within the scope of the description. In at least one example, the external systems 202 and 204 third-party systems that store industry-specific data that can communicate with or be accessed by the enterprise device(s) 212. According to various embodiments, external systems 202 and 204 may utilize software applications that function using external resources that are available through a third-party provider such as SaaS, PaaS, or IaaS service models. Such external systems 202, 204 include the third party systems accessible via the enterprise device(s) 212 using a software application (e.g., an integrated mobile software application or an API software application) that can be integrated with the computing system 206 to facilitate communication between software and systems by mapping computer-readable commands and data formats between systems. In another embodiment, the third party system may be accessible by the enterprise device(s) 212 using a web-based software interface (e.g., a website). In one example embodiment, the external systems 202, 204 include a relational database management system (e.g., such as a Microsoft SQL server) or other database server configured to store and retrieve data as requested by various software applications and/or a web-based software interface.

In certain embodiments, one or more of the systems described herein such as the user device (referring to either or both of the computing device 104 and the mobile device 106), the enterprise system 200, and/or the external systems 202 and 204 are, include, or utilize virtual resources. Such virtual resources include cloud resources or virtual machines. The virtual resources may utilize a cloud-computing configuration to provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud-computing configuration so that the resources may be shared as needed.

According to one embodiment, a user 110 may initiate an interaction with the enterprise system 200 via the user device 104, 106 and based thereon the enterprise system 200 may transmit, across a network 258, to the user device 104, 106 digital communication(s). In order to initiate the interaction, the user 110 may select a mobile application icon of a computing platform of the enterprise system, login via a website to the computing platform of the enterprise system, or perform various other actions using the user device 104, 106 to initiate the interaction with the enterprise system 200. The user 110 may initiate the interaction at periodic intervals (e.g., each month, each quarter, etc.) and perform a skills survey or access information related to human capital resources stored by the enterprise system 200 (i.e., the relational database management system). In other embodiments, the enterprise system 200 may initiate the interaction with the user 110 via the user device 104, 106. For instance, periodically the enterprise system 200 may transmit unprompted communication(s) to the user device 104, 106 that includes an embedded link, a web address (e.g., a uniform resource locator (URL)), a scannable code (e.g., a quick response (QR) code, barcode, etc.) to prompt the user 110 to interact with the enterprise system 200.

The skills survey may include a data transmission or communication in the form of a digital bit stream or a digitized analog signal that is transmitted across the network 258. Based on the user 110 of the user device 104, 106 providing one or more user inputs (e.g., via the user interface, via a speech signal processing system, etc.) as part of the skill survey, data related to various positions, roles, skills, employment locations, etc. may be received and data processing is performed thereon using, for example, processing device 220. This received data may then be stored to the storage device 224 or to a third party storage resource such as, for example, a cloud storage service or remote database. Additionally, this collected response data may be aggregated in order to allow the enterprise to have a sampling of responses from multiple users 110.

According to one embodiment, the aggregated data may be stored to storage device 224, database, and/or by external systems 202, 204 that can be accessed by a relational database management system (e.g., Microsoft SQL server, Oracle Database, MySQL, PostgreSQL, IBM Db2, Microsoft Access, SQLite, MariaDB, Snowflake, Microsoft Azure SQL Database, Apache Hive, Teradata Vantage, etc.) or other software system that enables users to define, create, maintain and control access to information stored by the storage device 224, database, and/or other external systems 202, 204. For instances, the relational database management system may maintain relational database(s) and may incorporate structured query language (SQL) for querying and updating the database. The relational database(s) may organize data into one or more tables or “relations” of columns (e.g., attributes) and rows (e.g., record), with a unique key identifying each row. According to various embodiments, each table may represent a role, a personal/unit profile, and/or position within the enterprise and the various attributes and/or records may indicate skills or attributes (e.g. unit attributes) attributed to the role, position and/or individual/profile.

For instance, the unit profiles may be classified based on their work experience, position, managerial experience, department, job functions, geographic regions, work shifts, level of association with the enterprise (e.g., employee, contractor, etc.), assignments performed, team, skillsets, traits, knowledge base, skill levels, skill types, skill category, or various other classifiers, identifiers, and/or rankings. Example position or title classifications may include senior management, middle managers, specialists, administration, administrative staff, supervisors, operators, contractors, contractor supervisors, contractor operators, employees, etc. Example department classifications may include accounting, management, customer service, information technology (IT), legal, human resources, sales, manufacturing, logistics, marketing, etc. Example category classifications may indicate attributes and/or characteristics such as physical and inherent abilities, business acumen, training programs, education level, etc. Each category may include a plurality of sub categories, and an example of the physical and inherent abilities category may include sub categories such as problem solving, business strategy, social skills, communication, etc. Storing the collected data to the relational database of the relational database management system may facilitate sorting of the data to filter based on various categories and/or subcategories and/or to generate various report(s) or performing data analytics thereon. According to one embodiment, the enterprise system 200 may maintain the relational database(s) that store such data in order to access this data for future gaps in roles and/or skills within the enterprise. In another embodiment, external systems 202, 204 may store the interaction or relational database.

The collected data may also have metadata associated therewith that can be accessed by the enterprise system 200. The metadata may include, for example, (i) sequencing data representing the data and time when the response data was created, (ii) modification data indicating the individual (such as user 110) that last modified specific information/data, (iii) weighting data representing the relative importance or magnitude of the skill/attribute, (iv) provider identifier data identifying the owner of the data (e.g., the entity that operates the enterprise system 200), and/or (v) other types of data that could be helpful to the enterprise in order to classify and analyze the collected data.

With respect to the position data that may be included within the metadata, a database, such as storage device 224, may include records that correspond to demand for a specific category, subcategory, or other data within the entity. The demand records may store a variety of data about the position including, for example, (a) skill level(s), (b) skill type (e.g., current, future, etc.), (c) tests that would need to be conducted to assess an individual's skill level, and/or (d) various other data. The demand data may enable the enterprise to evaluate how well the company is at filling gaps in resources.

In some embodiments, the enterprise system 200 may be configured to receive information about and/or identify resources (i.e. individuals, employees, contractors, etc.). For instance, a user 110 may identify a resource, their role/title, team name, area(s) of expertise, etc., which the relational database management system can access during a query. When a user 110 accesses the enterprise system 200 through the user device 104, 106, the information can be input into or otherwise accessed via the relational database management system. For instance, the user 110, via user device 104, 106, can access the enterprise system 200 and/or relational database management system using an Internet browser software application to access a web server in order to display a webpage of the enterprise. Alternatively, according to other embodiments, the enterprise system 200 can be accessed through an enterprise mobile software application installed on the user device 104, 106 that displays a GUI screen. According to various embodiments, the managers 210 and/or automated system 214 of the enterprise system 200 may also input and/or access the relational database(s).

According to one embodiment, the user device 104, 106 transmits a user-interface-transmit command to the relational database management system. In response to the user-interface-transmit command, the web server returns data associated with the skill survey, that the user device 104, 106 then processes to render a GUI screen that is presented to the user 110.

In some embodiments, the user device 104, 106 may also transmit system configuration data to the enterprise system 200, which may be used to authenticate the user and/or user device 104, 106. System configuration data can include, without limitation: (i) a unique identifier for the user device 104, 106 (e.g., a media access control (MAC) address hardcoded into a communication subsystem); (ii) a MAC address for the local network (e.g., a router MAC address); (iii) copies of key system files that are unlikely to change between instances when accessing the enterprise system 200; (iv) a list of applications running or installed on the user device 104, 106; and (v) any other data useful for ascertaining the identifiers underlying a support request or user communication.

According to some embodiments, the enterprise system 200 (e.g., relational database management system) may apply the collected response data to a trained model that incorporates algorithms in order to categorize or otherwise classify the data. Relational database(s) incorporate structured data that provides information in a standardized format. In particular, the relational database(s) may include a collection of information that organizes key data points with defined relationships for easy access, sorting, filtering, etc. According to one embodiment, data structures (e.g., data tables, indexes, views, etc.) may be separate from the physical storage structures, thereby enabling editing of the physical data storage without editing the data structure. In some instances, the relational database(s) may include a cloud-based relational database or a database-as-a-service functionality, which enable the enterprise to outsource database maintenance, and patching, infrastructure support requirements.

The enterprise system 200 may facilitate web-based data collection using a user interface that can feed and/or access a relational database management system in real time. The user interface may be used to present and collect information about resources, positions, roles, demands, skills, and/or abilities. According to various embodiments, the data can be filtered to identify data more relevant to a query. In some embodiments, the information displayed via the user interface may be resizable to enable the user to enlarge certain aspects. In addition, administrative users can access the skill survey on any user's behalf in order to troubleshoot or perform various functions on behalf of the user, although audits are logged as the real user making the changes. In some embodiments, administrative users can also set controls to limit which aspects of the skill survey can be used by certain users.

FIG. 2 depicts an example user interface display 201 for initiating a skill survey, in accordance with an embodiment of the present invention. The skill survey facilitates collecting information from enterprise employees (e.g., managers, supervisors, executives, etc.) that assess the skill(s) needed and/or other demand (i.e., the skills/competencies, proficiencies, timing of the need, etc.) needed by the enterprise and facilitates identifying aggregate overages and/or shortages of skills among workers of an enterprise. The skill survey can be used to categorize a role and/or job position of need or to directly assess an individual's ability to satisfy or supply the skill, deficiencies, etc. needed by the demand. Although each individual manager knows their own shortages, at an aggregate level, the disclosed skill survey may provide the enterprise with resources and tools to better plan for differing training initiatives, hiring needs, cutbacks, etc., and to provide optimal resource utilization for the enterprise. The user interface display 201 may include a “home” screen associated with a “home” tab 205 for the skill survey. Once the user interface display 201 is displayed, via a user interface of a user device, a user may select a “Get Started” input 203 to initiate the skill survey.

FIG. 3 depicts an example user interface display 301 for inputting position information as part of a skill survey, in accordance with an embodiment of the present invention, and associated with the “positions” tab 307 or screen of the skill survey. Once the skill survey has been initiated, a user can navigate to any tab (i.e., the “home” tab 305, “positions” tab 307, “demand” tab 309, “resources” tab 311, “skills” tab 313, and “summary” tab 315) and modify/update any information on any tab without navigating through the entire survey in a single sitting. The different tabs may not be accessible and/or visible to all users, and may have access restrictions placed thereon by administrative users. As the user inputs information via the input controls displayed as part of the skill survey, the information is saved in partial state without inputting a “save” functionality. The user interface display 301 that is displayed once the “positions” tab 307 is selected allows a user to input and/or access various data associated with certain positions via input controls, where the data includes, for example, a position identification number, a position title, a current individual/resource that fills the position, as well as the “criticality” and/or value provided by the position. The “criticality” designation allows the user to select from a preselected list of reasons as to why a resource is considered critical. In some embodiments, a user may select multiple reasons as to why a resource is considered critical, but the user is restrained from providing free-data entry associated with the criticality of the position. Further, information about how the position can be filled/performed can also be modified and/or accessed including, for example, indicating whether the position is an “entry level” position, a location where the individual can live in order to fulfill the requirements of the position, whether the position can be remote or if on-site attendance is required, and/or various other performance related information. Further, the name of the user that modifies the information associated with the individual/resource is also listed.

Example input controls may include, according to various embodiments, checkboxes, radio buttons, toggle buttons, switches, text inputs, dropdown buttons, floating action buttons, menu buttons, expandable buttons, raised buttons, call-to-action buttons, text buttons, ghost buttons, and/or various other interactive elements of the user interface through which the user may enter information into the system's interface. In one example, one input control may include an “export” button 317, a “help” button 319, dropdown buttons associated with “criticality” 321, proficiency level 323, location 325, worksite 327, etc.

FIG. 4 depicts an example user interface display 401 for providing user inputs related to skill demands required for various roles, in accordance with an embodiment of the present invention, and associated with the “demand” tab 409 or screen of the skill survey. As indicated above, a user can navigate to any tab (i.e., the “home” tab 405, “positions” tab 407, “demand” tab 409, “resources” tab 411, “skills” tab 413, and “summary” tab 415) and modify/update any information on any tab from the example user interface display 401 without navigating through the entire survey in a single sitting. Through user interface display 401, a user can select, via input controls, the skills/competencies needed and the skill level expected, via dropdown buttons 441, for each, collectively the “demand.” According to one embodiment, the user can similarly select the urgency of the “demand,” via dropdown buttons 443, by indicating whether there is a current demand or future demand. In one example embodiment, the user may indicate whether the need is current or how far into the future the demand is estimated to be needed (e.g., 3 months, 6 months, 1 year, etc.). This feature may be optional and if it is not indicated the system may assume that the demand is current. In some example embodiments, if the start date was included, then it would be assumed that the role and/or position is not yet present but is expected (e.g., due to an upcoming retirement of an existing resource, due to planned projects, etc.), and if the end date is not provided then it may be assumed that the role and/or position would always be necessary. Alternatively, if an end date was indicated, then it would indicate the depreciation date of the need. In addition, if the demand is associated with a skill rather than a position, the user could indicate how the demand for the need may change over time. For instance, the user may indicate that initially the demand is for a standard level competence, but as an aspect of the business becomes more prevalent then an advanced or expert level skillset may be needed at a certain point in the future.

In addition, a user can input notes, via text box input controls 445, which can indicate any information the user feels is relevant (e.g., date of entry, test needed in order to qualify, education level, etc.). In order for a “demand” entry to be certified/completed, a user may be required to provide a threshold number of skills associated with each role. For instance, the user may need to provide at least 5 skills per role. In order to add skills to a given role, the user may select the “add skills” button 439 to add additional skills needed for the role. In various embodiments, the demands expected of the role (generic role) and/or position (specific job) may be provided by the user/manager directly or may be inherited or otherwise indicated (e.g., by organizational mandates). For instance, the enterprise may require that all managerial roles have a minimum proficiency in a specific skill. In some embodiments, the manager's perceived needs may not necessarily align with what others in the organization feel the needs are. Thus, needs indicated by a manager can be differentiated from needs indicated by other individuals and/or can be overridden by administrative users.

In some instances, the user interface display 401 associated with the “demand” tab 409 may also be used to filter results shown via the user interface display 401 using various input controls such as the, the filter by category dropdown 429, the filter by subcategory dropdown 431, the title dropdown 435, and/or a “by resource in position” dropdown 437. Once the desired input controls have been set, the user may select the “apply filters” button 433 to populate results that conform to the filters set by the user. These input controls may be used, according to one example process, to identify areas of demand within an enterprise and to determine what skills, competence level, or other aspects of a role are needed within the enterprise. Advantageously, the user interface display 401 associated with the “demand” tab 409 facilitates collecting information from users (e.g., managers, supervisors, executives, etc.) that assess the skill(s) needed and/or other demand (i.e., the skills/competencies, proficiencies, timing of the need, etc.) needed by the enterprise. According to various embodiments, the skills input by a manager may be visible or hidden depending on whether a hiring manager or other superior agrees or disagrees with the skill requirements listed by the manager. In some embodiments, administrator users may control what “skill” or characteristic can be identified by a user as a need by providing a preselected list of skills (e.g. a skills library). In particular, administrator users can control what skills can be sourced from third-party sources. Advantageously, this may ensure that different terms are not used to describe the same skill, which could lead to difficulties in identifying resources that possess certain skillsets. Alternatively, users may select whatever skill they feel is appropriate/needed for the role and/or position. Optionally, if the user desires, the user may select the “export” button 417 to export the populated results and/or a “help” button 419 to obtain more information on how to use the user interface to obtain desired outcomes. Although not illustrated, the users that make any modifications to the data are logged and displayed so that managers can easily see which data edits were performed by whom.

FIG. 5 depicts an example user interface display 501 associated with a “resources” tab 511 for providing user inputs related to existing personnel resources associated with an entity, in accordance with an embodiment of the present invention. From the user interface display 501 associated with the “resources” tab 511, the user may optionally select one of the other tabs (i.e. home 505, positions 507, demand 509, skills 513, and/or summary 515) to perform other actions associated with the skill survey. Further, the user interface display 501 may be used to provide information about specific “resources” (i.e. individuals). For instance, the user may utilize input controls to indicate the team name to which a resource/individual is assigned, using a team name textbox 547, can indicate whether the resource is a subject matter expert, via a checkbox 549, and/or can input the areas of expertise or other notes, via the notes textbox 551, for each resource/individual. Also from the user interface display 501, if the user desires, the user may select the “export” button 517 to export the populated results and/or a “help” button 519 to obtain more information on how to use the user interface to obtain desired outcomes.

FIG. 6 depicts an example user interface display 601 associated with the “skills” tab 613 for providing inputs to filter results of existing personnel resources to identify necessary resource skills associated with an entity, in accordance with an embodiment of the present invention. This user interface display 601 associated with the “skills” tab 613 may provide a user with the ability to provide an assessment of each resource's/individual's abilities and compare those abilities to levels and skills that resources are expected to have in order to fulfill the needs of the role. The user may optionally select one of the other tabs (i.e. home 605, positions 607, demand 609, resources 611, and/or summary 615) to perform other actions associated with the skill survey. The user interface display 601 may be used to filter which results are populated based on various input controls including, for example, the by resource dropdown 653, the role title dropdown 655, the skill name dropdown 657, the category dropdown 629, the subcategory dropdown 631, and/or the checkbox indicator 659 to indicate (e.g. in order to identify the incomplete stored unit/resource profiles so that the results and stored unit/resource profiles can be certified) whether results should include incomplete rows only. Once the desired input controls have been selected, the user may select the “apply filters” button 633 in order to populate the results with the desired filters/attributes. According to various embodiments, certain data problems may be highlighted due to a certain coloring for easier identification. For instance, when the checkbox indicator 659 is selected, and the results are filtered when the user selects the “apply filters” button 633, the results that have data problems may be highlighted with certain colors depending on the problem.

The user interface display 601 associated with the “skills” tab 613 may also be used to provide, via an input control such as skill level drop down 641, a direct assessment of the resource's/individual's skill level and compare that skill level relative to the role's ideal skill level. Additional notes may also be provided for each resource/individual via the notes text box 651. In some embodiments, users may be permitted to provide inputs about themselves such as, for example, skills developed through training programs and/or skills they are interested in developing. Also from the user interface display 601, if the user desires, the user may select the “export” button 617 to export the populated results and/or a “help” button 619 to obtain more information on how to use the user interface to obtain desired outcomes.

FIG. 7 depicts an example user interface display 701 associated with the “summary” tab 715 for summarizing inputs provided by the user and identifying errors, and also for certifying the skill demand needed by the enterprise, in accordance with an embodiment of the present invention. The skill survey automatically saves entries to the server provided via the other tabs (i.e. home 705, positions 707, demand 709, resources 711, and/or skills 713); however, data is not considered certified until the user specifically certifies the data using the “certify” button 761. Once the user certifies the data by selecting the “certify” button 761, the state of the data changes. If a user wants to update information in one of the other tabs (i.e. home 705, positions 707, demand 709, resources 711, and/or skills 713), the user may do so and may then recertify the data via the “certify” button 761. The user interface display 701 associated with the “summary” tab 715 may also indicate errors and incomplete data that needs to be corrected and/or updated in order to certify the results. For instance, according to one embodiment, the “certify” button 761 may be disabled until the errors or incomplete data is corrected or updated. Each error type may have a different coloring associated with the error, which can be visible when the user for the stored unit profiles displayed via, for example, the various user interface displays 301, 401, 501, 601 associated with the other tabs (i.e. home 705, positions 707, demand 709, resources 711, and/or skills 713). For instance, non-limiting examples that the user interface display 701 may indicate may include that the “positions” tab 707 has information that has not been completed, the “demand” tab 709 requires a required level that has not been specified, or that the skill level has not been specified through the “skills” tab 713. In some examples, the issues that need to be resolved are displayed via hyperlinks that the user can select in order to directly link to the issues for correction. In some embodiments, certain inputs are not required and may be indicated on the user interface display 701 as not being completed, but would not prevent the user from certifying the results via the “certify” button 761. For example, the user interface display 701 may indicate that no subject matter experts were selected via the “resources” tab 711, but because that is not an error it is not considered an issue that needs to be resolved in order to certify the results.

The user interface display 701 may also display the resources/individuals within the enterprise, and may score the resource/individuals based on their skill level relative to enterprise standards or desired skill levels based on the role and/or position. For instance, the user interface display 701 may provide a user with micro-level insights into whether a resource's/individual's skills are above or below manager expectations. Also from the user interface display 701, if the user desires, the user may select the “export” button 717 to export the populated results and/or a “help” button 719 to obtain more information on how to use the user interface to obtain desired outcomes.

FIGS. 8-19 depict example user interface display 801, 901, 1001, 1101, 1201, 1301, 1401, 1501, 1601, 1701, 1801, 1901, respectively, that provide a skills dashboard and/or data summary of information derived from the skill survey, in accordance with embodiments of the present invention. In particular, the various skills dashboards and/or data summaries may provide the enterprise with macro-level and/or micro-level insights. For instance, micro-level insights may indicate which jobs can be done differently (e.g., offshore, nearshore, or onshore). Example macro-level insights that may be provided include insights into skill gaps across similar roles and within specific roles and/or positions within the enterprise. Advantageously, the macro-level insights may be used by the enterprise to identify gaps and determine whether additional resources need to be hired, need to be trained, and/or whether certain resources/individuals should be reallocated (e.g., promoted, reassigned, etc.). Some macro-level insights may also be used to determine whether certain skill gaps can be satisfied using remote workers.

The skills dashboards and/or data summaries, which in some cases may be referred to as tableaus, may provide various data points to help the enterprise determine what compensation would be appropriate for certain roles and/or positions. For instance, a manager may determine that certain resources/individuals are below the standards in certain skillsets and may use that information to determine a salary grade. In other examples, if a specific resource/individual is essential to the enterprise due to the rarity of a skill or because that resource/individual is a subject matter expert, then the salary grade may be higher. Managers may also use the skills dashboards and/or data summaries to determine whether certain roles and/or positions are better fulfilled via contractors, offshore workers, nearshore workers, etc., and may help the enterprise identify areas of cost savings.

User interface display 801 of FIG. 8 is an example skills dashboard, or tableau, that a user can use to derive or filter certain insights in order to interpret the data. Although the filters currently show “all” for each filter, the user could modify these results such that only certain “roles,” “subcategories,” “key resources,” “full time equivalent” (FTE), “manager name,” “required skills,” “skill gap,” “Deputy Chief Information Officers” (DCIOs), “vendor suppliers,” “specialized skills,” etc. User interface display 901 of FIG. 9 is an example filtered results of the top 50 required skills and the top 50 skill gaps based on the data derived from the data. Various other filters and insights may be derived based on the filters selected from the skills dashboard, or tableau.

Unlike most human resource tools available today, which often focus on advancing a resource's/individual's career growth, the disclosed systems and methods enable an enterprise to identify the needs for specific roles and/or positions. Further, the needs for the specific roles and/or positions may also enable the enterprise to assess the value of the resources/individuals employed by the enterprise. The distinction between roles and positions can be very important to an enterprise. A role may be more of a generic grouping of skills (e.g., a generalist) and a position may be more of a particular seat/position within an organization that a role is applied to (e.g., a specialist). For instance, the term “accountant” is a role within an organization, and the organization may indicate that all roles (e.g., accountants) have certain skillsets. Additionally or alternatively, within the organization there may be a need for a cost accountant position, which may have different skill requirements than a forensic accountant. Thus, the organization can define the skill requirements and assess the skills of resources within the organization that fulfill certain needs for certain roles and/or certain positions. In addition, by providing separate and distinct information related to roles that are separate from the information associated with positions, the disclosed systems and methods provide a framework for consistently applying, at an enterprise level (e.g. based on systematic directives/requirements) the skills that are important for each role and/or position. When the manager provides information via the “demand” tab described above, the manager may, for example, decide whether the demand is associated with a role or whether it is associated with a position. This distinction allows an enterprise to derive conclusions about role-based and/or position-based training and other actions that the enterprise may take to improve the workforce.

In some embodiments, the data collected via the skills survey may be used to compare and contrast resources/individuals with similar skillsets to determine why they may be more or less critical to the organization even if the data is the same or similar between the skill resources. Various conclusions may be derived from this data including, for instance, determining differences in skills, salaries, career histories, etc. to identify similarities and/or differences. For example, this system and method may provide a systematic grading or employee assessment process that would not be subject to the variations in assessments that might exist based on specific manager input, and may account not only for the skills, but may take into account the career histories, criticality of the skills, salaries, etc. in order to provide a more thorough assessment. In one embodiment, one conclusion that may be identifies is whether resources/individuals with similar skill sets are considered by their managers to be more or less critical due to their role, position, seniority, line of business, etc. In addition, based on the demand inputs, reports may be generated to provide insight into how different manager opinions and/or expectations change over time and how certain needs/demands change over time without overwriting the prior demands, opinions, expectations, etc.

The systems and methods disclosed herein may be integrated with other third-party software that may be used to track various other aspects of resources/individuals. For instance, one third-party software may be used to collect information about whether a resource/individual is willing to relocate, certain interests expressed by an individual, current employment location, work experience, projects, training programs in which the individual is enrolled or has taken, skill assessments completed, etc. In addition, third-party systems may be used to indicate current projects and workload of resources in order to better distribute the workload amongst resources/individuals. The data from these third-party resources may be mined to incorporate information into the stored unit profiles for each resource/individual in order to identify resources/individuals within the enterprise that have the required skills and needed proficiencies. Further, these resources/individuals can be ranked in accordance with their skill level in order to identify a best fit for the role and/or position. In particular, the skill survey can assist with identifying the resource/individual that has the right skills, skill level, availability (at the right time), and/or interest and indicate whether the individual would be will to relocate (if needed) in order to satisfy the demand. Further, predictions could be made about the future abilities of resources (e.g., due to training, performance improvements, etc.) to meet certain demands/needs. For example, Machine learning could also be used to identify the resources predicted to be most successful in a role and/or position based on the data (e.g., recent promotions, training conducted, time in position, etc.) about that resource/individual. In another example, by integrating performance review information, years of experience, and other data, it may be possible to identify common characteristics amongst individuals that are exceeding expectations in their current role and identify future roles that might better align with their skillset. Feedback can be used to train a machine learning engine so that the machine learning engine learns which resources were successful in their roles/positions based on certain skillsets. Once the machine learning engine is trained, it can be used to make recommendations on individuals, training programs, or other parameters to improve the existing workforce. This data may be helpful to the enterprise because it will enable the enterprise to determine whether hiring a full-time individual with certain skills is better, or whether it would be more advantageous to hire a part-time individual with certain skillsets that would need training to reach the desired skill level based on the data indicating that a certain training program would make up the difference in skill level in order to satisfy the demand.

A machine learning program, machine learning algorithm, or machine learning module, as used herein, is generally a type of AI including one or more algorithms that can learn and/or adjust parameters based on input data provided to the algorithm. In some instances, machine learning programs, algorithms, and modules are used at least in part in implementing AI functions, systems, and methods.

AI and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine-learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine-learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine-learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

In general, machine learning models may include supervised techniques that can operate on labeled content data and include instructions informing the system which outputs are related to specific input values, or unsupervised learning techniques that can identify and characterize hidden structures of unlabeled content data.

In such instances, supervised software processing can rely on iterative training techniques and training data to configure neural networks with an understanding of individual words, phrases, subjects, sentiments, and parts of speech. As an example, training data is utilized to train a neural network to recognize that certain phrases all relate to the same general subject matter when the words are observed in proximity to one another at a significant frequency of occurrence. Supervised learning software systems are trained using content data that is well-labeled or “tagged.” During training, the supervised software systems learn the best mapping function between a known data input and expected known output (i.e., labeled or tagged content data). Supervised learning software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a calculated probability and a desired threshold probability. Supervised learning software systems implement techniques that include, without limitation, Latent Semantic Analysis (“LSA”), Probabilistic Latent Semantic Analysis (“PLSA”), Latent Dirichlet Allocation (“LDA”), and Bidirectional Encoder Representations from Transformers (“BERT”).

In contrast, unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-means clustering, Mean-Shift clustering, Density-based clustering, Spectral clustering, Principal Component Analysis, and Neural Topic Modeling (“NTM”).

In general, neural networks are a subfield of machine learning that take inspiration from biological neural networks. A neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks. Neural networks are trained using training set content data that comprise sample tokens, phrases, sentences, paragraphs, or documents for which desired subjects, content sources, interrogatories, or sentiment values are known. A labeling analysis is performed on the training set content data to annotate the data with known subject labels, interrogatory labels, content source labels, or sentiment labels, thereby generating annotated training set content data.

Neural networks may perform a supervised learning process where known inputs and known outputs are utilized to categorize, classify, or predict a quality of a future input. However, additional or alternative embodiments of the machine-learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine-learning algorithm may adjust the weight coefficients until any error in the output data generated by the algorithm is less than a predetermined, acceptable level. For instance, the training process may include comparing the generated output, produced by the network in response to the training data, with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between-1 and 1) may be used to modify the previous coefficient, e.g., a propagated value. The machine-learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

Various neural networks exist that may be utilized by various AI systems described herein. For instance, an artificial neural network (ANN), also known as a feedforward network, may be utilized, e.g., an acyclic graph with nodes arranged in layers. An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine-learning program may include a feedback system suitable to provide the connection(s) between subsequent and previous layers of the network.

Referring back to the skill survey, in some embodiments, such as that displayed via the data summary associated with user interface display 1801, information about industry or other external resources may be obtained (e.g., via third-party resources) in order to better inform various conclusions derived from the data. For example, in one embodiment the data may be used to identify industry expectations for each role (e.g., role-specific and/or position-specific skillsets that are commonly required within a given industry). This information may be used to supplement/override the skills indicated by a manager as part of the skills survey, and may also be used to better name/advertise the position based on the skills needed by the demand in accordance with industry standards. If available, third-party data could also be used to determine industry/market pay for certain roles and/or skills, changes in roles to better match industry expectations, determine relationships between certain training programs and skillset development. Third-party data could be used to determine whether the enterprise's current resources/personnel match industry expectations for a given role, whether role/position titles should change to better align with industry standards, determine whether additional skills need to be assessed in order to be more in line with industry assessment standards, and/or derive relationships between positions and skills.

In some embodiments, skills and/or skillsets may be more finely differentiated and identified via the data summaries. For instance, adjacent skills that are similar to primary skills or that commonly accompany primary skills may be identified. These adjacent skills may help an enterprise identify resources with adjacent skills that could develop primary skills that are needed by the demand. In some embodiments, machine learning could also be used to infer conclusions from the data that might not be readily apparent. For instance, the machine learning algorithms may be used to infer best resource matches for demands/needs based on a large set of resources and skill characteristics and provide recommended matches.

In some embodiments, various search functions can be very specific in order to allow managers to identify existing resources/individuals that can satisfy enterprise demands. For instance, managers may be able to indicate, in a non-limiting example, that the demand requires a resource with ten years of experience with an expert proficiency level in software development and at least a beginner skill in written communication, and the systems and methods may identify individuals that satisfy the demand.

FIG. 20 depicts a block diagram of an example method 2000 for unit resource management, in accordance with an embodiment of the present invention. At block 2005, a relational database management system receives, from a user device via a network, one or more user inputs indicating (a) demand of one or more attributes and (b) an associated requirement level needed to satisfy the demand, the one or more user inputs being provided via one or more user interface input controls displayed via a user interface of the user device. At block 2010, the relational database management system performs unit resource management, where the performing includes (i) retrieving data stored by one or more databases of the relational database management system, the data comprising a plurality of stored unit profiles each comprising associated unit attributes, and (ii) filtering the data to select one or more stored unit profiles comprising associated unit attributes determined to align with the demand of the one or more attributes. At block 2015, the relational database management system transmits, to one or more computing devices via the network, an output that includes the selected one or more stored unit profiles, and the transmitting facilitates displaying the output via the one or more computing devices.

Further, according to one or more embodiments, the one or more user inputs may include skills and competencies that a user identifies as being needed by an enterprise, and the associated requirement level needed to satisfy the demand includes a human capital skill level associated with the skills and competencies. In various embodiments, the plurality of stored unit profiles may include human capital skills and competencies attributed to employees of an enterprise, where each stored unit profile is associated with an employee of the enterprise. Further, in some embodiments, the human capital skills and competencies attributed to the employees are derived from inputs provided by managers of the employees.

In some embodiments, the one or more stored unit profiles include a type of human capital skillset, and the filtering includes identifying unit attributes comprising micro-level attributes and macro-level attributes. Further, a plurality of stored unit profiles is ranked based on the micro-level attributes and macro-level attributes, and based on a threshold the one or more stored unit profiles are selected from the plurality of stored unit profiles, where the one or more stored unit profiles have scores that surpass the threshold. In various embodiments, the unit resource management performed further includes incorporating machine learning to generate a prediction about which of the one or more selected stored unit profiles is most likely to satisfy the demand, and providing a visual representation indicating which of the selected one or more stored unit profiles is predicted as being most likely to satisfy the demand.

According to one or more embodiments, one or more filters may be selected in order to identify a unit profile that satisfies an availability requirement to ensure that the resource can satisfy the demand at the time needed. Additionally or alternatively, in one or more embodiments, one or more filters may be selected to identify one or more interests of the resource(s) identified, which may be used to identify resource(s) that may be interested in taking on a role and/or fulfilling the position. According to various embodiments, a user may also input cost information indicating rates or pay ranges based on expected criticality, experience, and/or actual pay ranges derived from third-party data for individuals with the same or similar skillsets.

According to one embodiment, machine learning is used to identify one or more stored unit profiles comprising associated unit attributes determined to align with the demand of the one or more attributes. In addition, machine learning may be used to suggest alternative positions for resources based on their skillsets, identify skill proficiency improvements that are successful in helping resources/individuals best develop certain skills, identify resources/individuals that are at the highest risk of leaving the enterprise (e.g., due to being overqualified based on compensation, due to skillsets not aligning with their position/role, etc.).

FIG. 21 depicts a block diagram of an example method 2100 for unit resource management, in accordance with an embodiment of the present invention. At block 2105, a server receives, from a user device via a network, one or more queries indicating (a) demand of one or more human capital skillsets within a segment of an enterprise, and (b) an associated competency level needed to satisfy the demand. At block 2110, the server performs strategic resource management, where the performing includes retrieving data that includes a plurality of stored resource profiles, where each resource profile has associated human capital skillsets. In addition, one or more stored resource profiles of one or more individuals is identified from the plurality of stored resource profiles, where the one or more stored resource profiles include a plurality of human capital skillsets, the one or more stored resource profiles being identified based on one or more human capital skillsets of the one or more individuals most closely aligning to the demand. Further, at block 2115, an output is transmitted to one or more computing devices via the network, where the output includes the one or more stored resource profiles of the one or more individuals, and the transmitting facilitates displaying the output via the one or more computing devices.

FIG. 22 depicts a block diagram of an example method 2200 for unit resource management, in accordance with an embodiment of the present invention. At block 2205, a relational database management system receives, from a user device via a network, one or more user inputs associated with unit resource management, the one or more user inputs indicating (a) position data associated with a position of the enterprise, (b) demand for one or more unit resources comprising one or more attributes, and (c) an associated requirement level needed to satisfy the demand. Further, the one or more user inputs are provided via one or more user interface input controls displayed via a user interface of the user device. At block 2210, the one or more user inputs are compared to a plurality of threshold requirements needed to certify all data provided via the one or more user inputs. At block 2215, an output is transmitted to one or more computing devices via the network and displayed via the one or more computing devices, where the output indicates whether all of the data provided via the one or more user inputs satisfies the plurality of threshold requirements.

According to various embodiments, the method further includes receiving, based on all of the data provided via the one or more user inputs satisfying the plurality of threshold requirements, a request to certify the data. In response, the data may then be certified. In some embodiments, the method further includes generating and displaying, based on at least a portion of the data provided via the one or more user inputs being deficient in at least one of the plurality of threshold requirements, an error message indicating an issue that needs to be corrected before the data can be certified.

In some embodiments, the one or more user inputs further include an indication of a physical location at which the demand could be satisfied. Further, the physical location may include at least one of a territorial region and a physical worksite facility. In some embodiments, the one or more user inputs may further include an attribute type associated with the urgency of the demand.

In some embodiments, the one or more user inputs further include a resource assessment of at least one unit resources of the enterprise, where the resource assessment includes an indication of areas of expertise associated with the at least one unit resource. In some embodiments, the resource assessment further indicates one or more resource attributes attributed to the at least one unit resource, and a skill level associated with the one or more resource attributes. The method may also include assigning a score to the one or more resources of the enterprise, where the score is based on one or more resource attributes attributed to the at least one unit resource. Further, the resource assessment may be performed by a manager of the at least one unit resource.

The method may also include generating a summary configured to provide insights of various data derived from the one or more user inputs. In some embodiments, the method further includes transmitting to and displaying via the one or more computing devices, the summary, where the summary is configured to be filtered based on one or more parameters selected, via one or more input controls, by a user of at least one of the one or more computing devices. In some example embodiments, the summary may be further configured to provide insights of enterprise data derived from third-party systems.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®”, “Windows®”, “macOS®”, “iOS®”, “Android®”, and the like may be subject to trademark rights in various jurisdictions throughout the world and are used here only in reference to the products or services properly denominated by the marks to the extent that such trademark rights may exist.

What is claimed is:

1. A relational database management system for unit resource management, the system comprising:
a memory;
one or more processors in communication with the memory; and
program instructions executable by the one or more processors via the memory to:
receive, by the relational database management system from a user device via a network, one or more user inputs indicating (a) demand of one or more attributes and (b) an associated requirement level needed to satisfy the demand, the one or more user inputs being provided via one or more user interface input controls displayed via a user interface of the user device;
perform, by the relational database management system, unit resource management, the performing including:
retrieving data stored by one or more databases of the relational database management system, the data comprising a plurality of stored unit profiles each comprising associated unit attributes; and
filtering the data to select one or more stored unit profiles comprising associated unit attributes determined to align with the demand of the one or more attributes; and
transmit, to one or more computing devices via the network, an output comprising the selected one or more stored unit profiles, the transmitting facilitating displaying the output via the one or more computing devices.

2. The relational database management system of claim 1, wherein the one or more user inputs comprise skills and competencies that a user identifies as being needed by an enterprise, and wherein the associated requirement level needed to satisfy the demand comprises a human capital skill level associated with the skills and competencies.

3. The relational database management system of claim 1, wherein the plurality of stored unit profiles comprise human capital skills and competencies attributed to employees of an enterprise, each stored unit profile being associated with an employee of the enterprise.

4. The relational database management system of claim 3, wherein the human capital skills and competencies attributed to the employees are derived from inputs provided by managers of the employees.

5. The relational database management system of claim 1, wherein the one or more stored unit profiles comprises a type of human capital skillset and wherein the filtering comprises:
identifying unit attributes comprising micro-level attributes and macro-level attributes;
ranking a plurality of stored unit profiles based on the micro-level attributes and macro-level attributes; and
selecting, based on a threshold, the one or more stored unit profiles from the plurality of stored unit profiles, the one or more stored unit profiles having scores that surpass the threshold.

6. The relational database management system of claim 1, wherein the unit resource management performed further includes:
incorporating machine learning to generate a prediction about which of the one or more selected stored unit profiles are most likely to satisfy the demand; and
providing a visual representation indicating which of the selected one or more stored unit profiles is predicted as being most likely to satisfy the demand.

7. A computing system for database server querying, the computing system comprising:
one or more computer readable storage media;
one or more processors in communication with the one or more computer readable storage media; and
program instructions executable by the one or more processors via at least one computer readable storage medium of the one or more computer readable storage media to:
receive, by a server from a user device via a network, one or more queries indicating (a) demand of one or more human capital skillsets within a segment of an enterprise and (b) an associated competency level needed to satisfy the demand;
perform, by the server, strategic resource management, the performing including:
retrieving data comprising a plurality of stored resource profiles, each resource profile having associated human capital skillsets; and
identifying one or more stored resource profiles of one or more individuals from the plurality of stored resource profiles, the one or more stored resource profiles comprising a plurality of associated human capital skillsets, the one or more stored resource profiles being identified based on one or more human capital skillsets of the one or more individuals most closely aligning to the demand; and
transmit, to one or more computing devices via the network, an output comprising the one or more stored resource profiles of the one or more individuals, the transmitting facilitating displaying the output via the one or more computing devices.

8. A computer-implemented method for unit resource management, the method comprising:
receiving, by a relational database management system from a user device via a network, one or more user inputs associated with unit resource management, the one or more user inputs indicating:
(a) position data associated with a position of the enterprise;
(b) demand for one or more unit resources comprising one or more attributes; and
(c) an associated requirement level needed to satisfy the demand;
wherein the one or more user inputs being provided via one or more user interface input controls displayed via a user interface of the user device;
comparing the one or more user inputs to a plurality of threshold requirements needed to certify all data provided via the one or more user inputs; and
transmitting, to one or more computing devices via the network, and displaying, via the one or more computing devices, an output indicating whether all of the data provided via the one or more user inputs satisfies the plurality of threshold requirements.

9. The computer-implemented method of claim 8, wherein the method further comprises receiving, based on all of the data provided via the one or more user inputs satisfying the plurality of threshold requirements, a request to certify the data.

10. The computer-implemented method of claim 8, wherein the method further comprises, generating and displaying, based on at least a portion of the data provided via the one or more user inputs being deficient in at least one of the plurality of threshold requirements, an error message indicating an issue that needs to be corrected before the data can be certified.

11. The computer-implemented method of claim 8, wherein the one or more user inputs further include an indication of a physical location at which the demand could be satisfied.

12. The computer-implemented method of claim 11, wherein the physical location includes at least one of a territorial region and a physical worksite facility.

13. The computer-implemented method of claim 8, wherein the one or more user inputs further include an attribute type associated with the urgency of the demand.

14. The computer-implemented method of claim 8, wherein the one or more user inputs further include a resource assessment of at least one unit resource of the enterprise, the resource assessment including an indication of areas of expertise associated with the at least one unit resource.

15. The computer-implemented method of claim 14, wherein the resource assessment further indicates:
one or more resource attributes attributed to the at least one unit resource; and
a skill level associated with the one or more resource attributes.

16. The computer-implemented method of claim 14, wherein the method further includes assigning a score to the one or more resources of the enterprise, the score being based on one or more resource attributes attributed to the resource.

17. The computer-implemented method of claim 14, wherein the resource assessment is performed by a manager of the at least one unit resource.

18. The computer-implemented method of claim 8, wherein the method further includes generating a summary configured to provide insights of various data derived from the one or more user inputs.

19. The computer-implemented method of claim 18, wherein method further includes transmitting to and displaying via the one or more computing devices, the summary, wherein the summary is configured to be filtered based on one or more parameters selected, via one or more input controls, by a user of at least one of the one or more computing devices.

20. The computer-implemented method of claim 18, wherein the summary is further configured to provide insights of enterprise data derived from third-party systems.
